(19) United States
(12) Patent Application Publication
(10) Pub. No.: US 2026/0247275 A1
(43) Pub. Date: Aug. 20, 2026

(54) SERVICE MANAGEMENT ORCHESTRATION AND DISTRIBUTED UNIT DIRECT CONTROL NETWORK ENERGY SAVING USING O1 INTERFACE

(71) Applicants: RAKUTEN SYMPHONY, INC., Tokyo (JP); Rakuten Mobile, Inc., Tokyo (JP)

(72) Inventors: Lingasamy VELUCHAMY, Karnataka (IN); Awn MUHAMMAD, Tokyo (JP); Pankaj Tanaji SHETE, Tokyo (JP); Kexuan SUN, Weybridge, Surrey (GB)

(73) Assignees: RAKUTEN SYMPHONY, INC., Tokyo (JP); Rakuten Mobile, Inc., Tokyo (JP)

(21) Appl. No.: 18/869,937

(22) PCT Filed: Aug. 28, 2024
(86) PCT No.: PCT/US2024/044116

§ 371 Date: Nov. 27, 2024

(30) Foreign Application Priority Data
Oct. 4, 2023 (IN) 202341066661

(51) Int. Cl. H04W 52/02; H04L 41/5009

(52) U.S. Cl. CPC H04W 52/0203; H04L 41/5009

(57) ABSTRACT

A method, apparatus, and system for Service Management and Orchestration (SMO) and distributed unit direct control network energy saving (NES) using an O1 interface may be provided and may include, sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface on a management plane (M-Plane) or a Control Plane (C-plane) based at least in part on the received message; and sending, by the O-DU to the SMO, a notification indicating whether activating the TRx control configuration was successful.

### FIELD

The present disclosure relates to Service Management and Orchestration (SMO) and distributed unit direct control network energy saving (NES) implementations using O1 interface.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronthaul (OF) Control (C), User (U), Synchronization (S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

In the related art, a O-eNB 160 or underlying RAN elements (NF's) (which may be controlled with SMO 110 over the O1 interface as illustrated in FIG. 1) may be put into a network energy saving (NES) state in order to reduce cost of operation and increase network efficiency. This may include, for example, transferring network load to other candidate cells, or draining traffic on the existing cell before moving to energy saving state.

### SUMMARY

Conventional methods used in the related art may not fully consider how to efficiently analyze the need to activate the NES state, trigger the appropriate elements, and convey the proper information needed to activate NES for the constituent network elements.

According to embodiments, a method for Service Management and Orchestration (SMO) and distributed unit direct control network energy saving (NES) using an O1 interface may be provided and may include, sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface on a management plane (M-Plane) or a Control Plane (C-plane) based at least in part on the received message; and sending, by the O-DU to the SMO, a notification indicating whether activating the TRx control configuration was successful.

Based on the above embodiments, SMO-based NES approaches using the O1 interface may allow for more optimized energy consumption across the network since decisions may be made using real-time data and/or predictive analysis to adjust power profiles, improved automation, as well as more optimized resource allocation.

According to embodiments, an Open Radio Access Network (O-RAN) Distributed Unit (O-DU) may be provided, and configured to: send network energy saving (NES) information comprising at least one of network traffic, load performance measurements, and Key Performance Indicators (KPI's) to a service management and orchestration (SMO); receive a message indicating when to apply a TRx Control configuration to an O-RAN Radio Unit (O-RU); and set a transceiver (TRx) Control configuration at the O-RU over a fronthaul (FH) interface one of a management plane (M-Plane) or a control plane (C-Plane) based at least in part on the received message; and send to the SMO, a notification indicating whether activation of the TRx control configuration was successful.

According to embodiments, at least one non-transitory computer-readable recording medium having recorded thereon instructions executable to implement a method may be provided, the method including sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface one of a management plane (M-Plane) or a control plane (C-Plane) based at least in part on the received message; and sending, by the O-DU to the SMO, a notification indicating whether activation of the TRx control configuration was successful.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

FIG. 2 illustrates a system architecture diagram for O-RAN elements and interfaces according to an embodiment;

FIG. 3 illustrates a general call flow diagram for network energy saving according to an embodiment;

FIG. 4A-5C illustrates a call flow diagram for Carrier and Cell Switch Off/On network energy saving according to an embodiment;

FIG. 5A-5C illustrates a call flow diagram for TRx network energy saving according to an embodiment;

FIG. 6A-6B illustrates a call flow diagram for TRx Control Implementation by SMO/O-DU direct control or O-DU driven based on policy according to an embodiment;

FIG. 7A-7C illustrates a call flow diagram for advanced sleep mode network energy saving according to an embodiment;

FIG. 8 is a block diagram of an example data structure for gNB-DU(O-DU)/gNB-CU(O-CU) IM/DM to support Network Energy Saving according to an embodiment;

FIG. 9 is a block diagram of an example data structure for O-DU network energy saving according to an embodiment;

FIG. 10 is a block diagram of an example data structure for O-DU network energy saving using TRx control according to an embodiment;

FIG. 11 is a block diagram of an example data structure for O-DU network energy saving using Advanced Sleep Mode according to an embodiment;

FIG. 12 is a block diagram of an example data structure for O-CU network energy saving according to an embodiment;

FIG. 13 is a block diagram of an example data structure for Direct TRx Control by O-DU using M-Plane according to an embodiment;

FIG. 14 is a flowchart diagram of an example method for Rx Control Implementation by SMO/O-DU direct control according to an embodiment;

FIG. 15 is a diagram of an example environment in which systems and/or methods, described herein, may be implemented; and

FIG. 16 is a diagram of example components of a device according to an embodiment.

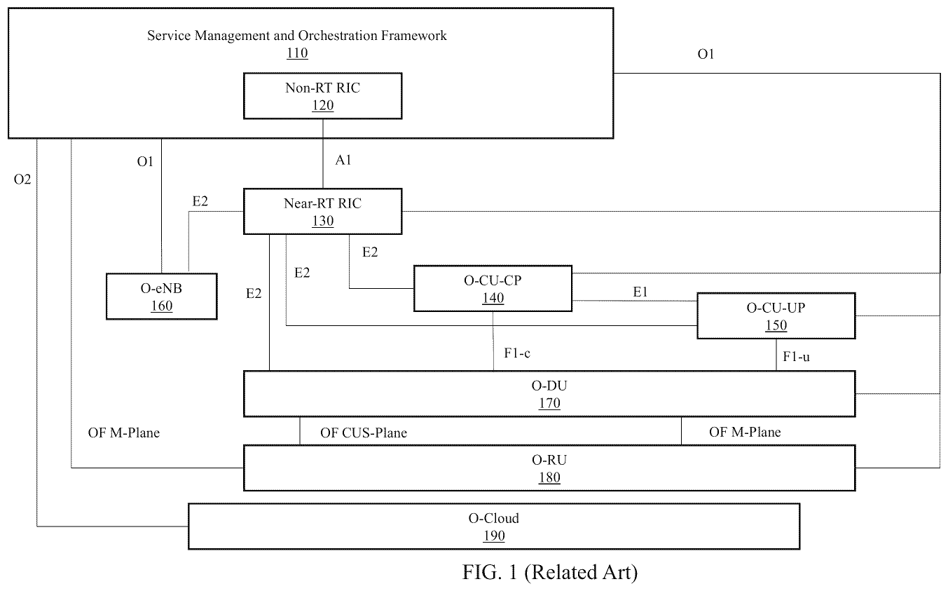

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, a method, apparatus, and system for Service Management and Orchestration (SMO) network energy saving (NES) using an O1 interface may be provided and may include, sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface on a management plane (M-Plane) or a Control Plane (C-plane) based at least in part on the received message; and sending, by the O-DU to the SMO, a notification indicating whether activating the TRx control configuration was successful. Based on the above embodiments, SMO-based NES approaches using the O1 interface may allow for more optimized energy consumption across the network since decisions may be made using real-time data and/or predictive analysis to adjust power profiles, improved automation, as well as more optimized resource allocation.

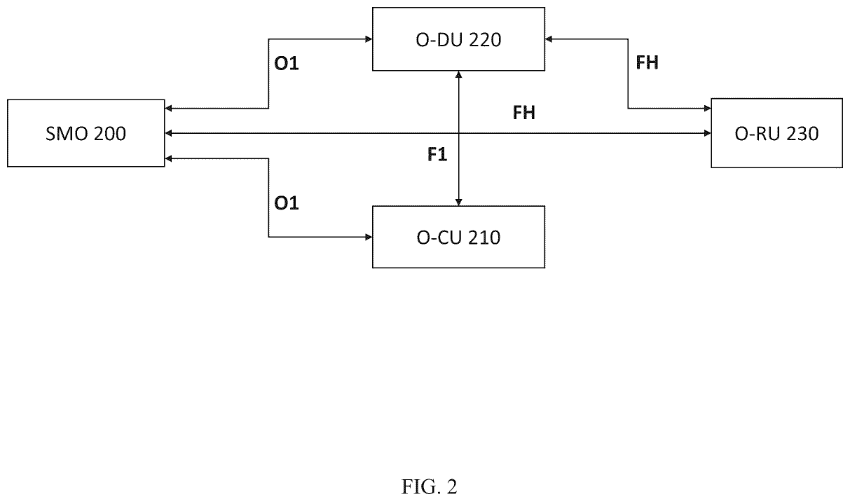

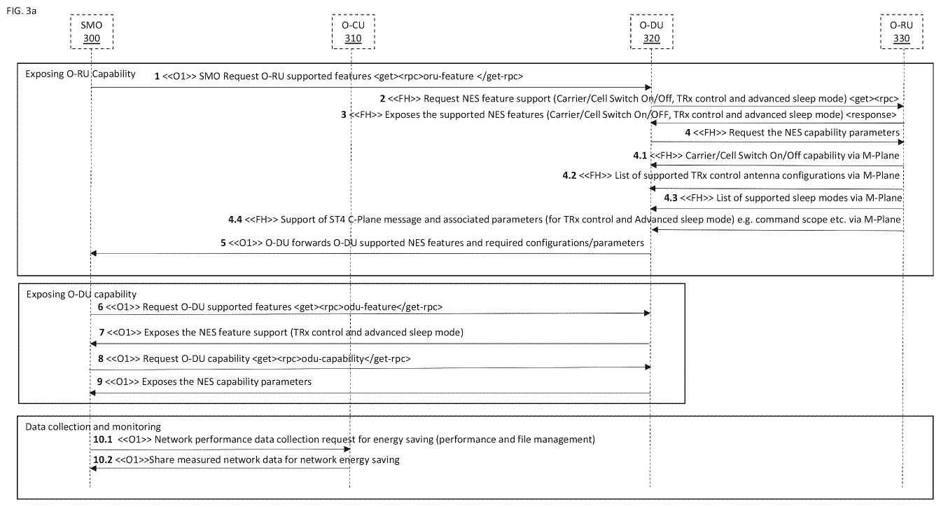

FIG. 2 illustrates a system architecture diagram for O-RAN elements and interfaces according to an embodiment. In particular, Service Management and Orchestration (SMO) 200, O-CU 210, O-DU 220, and O-RU 230 may be provided.

Referring to FIG. 2, SMO 200 may be configured to communicate with O-CU 210 and O-DU 220 via a O1 interface, and vice-versa. O-CU 210 and O-DU 220 may be able to communicate with each other via a F1 interface. O-RU 230 may be able to communicate with SMO 200 and O-DU 220 via fronthaul (FH).

SMO 200 may be responsible for triggering an energy saving use-case to O-DU 220 via the O1 interface, and O-DU 220 in turn may implement the use-case via either a management plane (M-Plane) or a control plane (C-Plane), depending on the specific implementation and use-case.

According to embodiments, SMO 200 could coordinate with the O-DU 220 and O-CU 210, to enable sleep modes/TRx control that does not have an impact on F1 interface (for example, Sleep Mode (SM) #0 and SM #1 with light sleep up to 1 frame (10 ms)). According to embodiments, SMO 200 may implement other sleep modes (e.g., SM #3 and SM #4 with deep and hibernate sleep (10 ms to “x” seconds) using O1 interface.

It should be noted that the F1 interface, according to specifications (such as in the Third Generation Partnership Project (3GPP) may have limitations for providing policy for specifically instructing cells/RF channels to be deactivated/muted/be put to sleep for energy saving use-cases. In this regard, O-CU 210 may be able to provide the timer for cells to be activated or deactivated, but the F1 interface may not inherently be able to differentiate between specific different use-cases.

According to an embodiment, a hierarchical deployment may be provided, wherein O-RU 230 is configured to expose its energy saving capability to O-DU 220 via a fronthaul management plane (FH M-Plane), which may forward the capability to SMO 200 either through an aggregation model, or as a configuration file via the O1 interface.

According to an embodiment, a hybrid deployment may be provided, wherein SMO 200 can directly understand/retrieve the capability from O-RU using a remote procedure call (RPC), e.g., <rpc><get-config>.

According to embodiments, O-DU 220 may be able to expose network energy saving (NES) related parameters to SMO 200. In particular, for example, for a Carrier and Cell Switch Off/On use-case, O-DU 220 may be able to expose energy saving support and associated parameters (to be investigated in O-DU perspective).

According to another embodiment for RF Channel Reconfiguration using a transceiver (TRx) control use-case, O-DU 220 may be able to expose to SMO 200 a list of TRx control configurations (including Antenna array configurations) a list of supported sleep modes (SM) (SM #0, SM #1, SM #2, and SM #4), wake-up duration associated with sleep modes, TRx control antenna configurations transition, as well as other associated parameters (to be investigated in O-DU perspective).

According to another embodiment for Advanced Sleep Mode (ASM) use-case, O-DU 220 may be able to expose to SMO 200 sleep modes (SM #0, SM #1, SM #2, and SM #4), wake-up duration of each sleep mode, and other associated parameters (to be investigated in O-DU perspective).

According to embodiments, O-CU 210 may be able to expose NES related parameters to SMO 200. This may include, but may not necessarily be limited to, RRC configuration related parameters, UE context related parameters, neighbor cell related parameters, and other parameters (to be investigated in O-CU perspective).

### Transceiver (TRx) Control Implementation Using O1 Interface

According to embodiments, SMO 200 may be responsible for providing policies on when to activate the specific transceiver (TRx) control configuration by indicating the mask name. Subsequently, O-DU 220 can activate the same configuration in O-RU 230 by including a respective antenna mask in Section Type 4 Control Plane (ST4 C-Plane) message.

According to embodiments, cell activation/deactivation features may be included. SMO 200 may directly activate the Cells in O-DU 220. SMO 200 could configure the cells in O-DU 220, which in turn configures the carrier in O-RU 230, subsequently, SMO 200 activates the cells. According to another case, the SMO 200 may only configure cells that the O-DU 220 serves and their corresponding carriers over O1 interface towards O-DU 220. O-DU 220 may then consequently configure (activate/deactivate) tx/rx-array-carriers over their FH interfaces. It should also be appreciated that according to another embodiment, an O-DU 220 may only activate or deactivate the tx/rx array-carriers in O-RU 230 that belongs to the cells that the O-DU 220 serves.

According to embodiments, a notification framework may be provided. SMO 200 may subscribe to O-CU 210, O-DU 220, O-RU 230 (only in hybrid deployment) via the notification framework. For example, SMO 200 can get notification from O-DU 220 on cell activation/deactivation and tr[x]-array carrier state of O-RU 230.

According to embodiments, odu-id may be provided. Odu-id and ru-instance-id based carrier activation and deactivation, Trx control, and sleep mode implementation may be facilitated accordingly. In WG4 yang models, odu-id may be defined inside [tr]x array carriers. According to embodiments, SMO 200 could use odu-id and ru-instance-id to implement Carrier and Cell Switch Off/On use-case, TRx control use-case, and ASM use-case in specific O-RU 230 through O-DU 220, wherein odu-id could be used as the common reference parameter. SMO 200 could use aggregate models to put to sleep/deactivate the specific carrier/array with the assistance of the corresponding carrier/array name in O-RU yang models.

According to embodiments, the O1 interface may allow for a variety of parameters to be sent to the SMO 200

Particularly, data/parameters which may be sent over O1 may include, but necessarily limited to, user throughputs, power consumption, QoS, User pebeam, current O-Ru configurations, cell configurations, UL/DL delay (min, max and average), transmission and reception window, distributed delay including FH delay between O-DU 220 and O-RU 230, etc.

O-DU 220 capability which can be exposed over O1 interface may further include number of SSB beams supported per TRx control configuration, number of data beams (e.g., PUSCH) per TRx control configuration, beam sweep ranges as a function of number of antenna array elements, or it may be a number of beams per configuration as reported based on O-RU capability.

O-CU related parameters which could be sent may include TRx configuration change by SMO 200 to O-CU 210 and O-DU 220 so that O-CU 210 may be aware of RRC configuration and gNB-DU configuration update is in coordination with O-DU 220. It may also include CSI-RS ports to be updated as per current TRx control configuration (see for example 3GPP TS 38.802—Clause 7.14). It may also include SSB coverage area changes per TRx control configuration—RRC configuration related changes (indicated to O-CU 210 by either near-RT RIC or non-RT RIC). Other O-CU related parameters may also configuration update message between O-CU and O-DU (gNB configuration update and gNB-CU configuration update), and CSI measurement and reporting (both periodic and aperiodic).

Notifications which may be sent over O1 interface may include, but not necessarily limited to, SMO 200 subscribing to notifications, energy saving state (e.g., energySavingState) change notifications, [tx]-array carrier state change notifications, and TRx control configuration changes notifications to O-CU 210 via O1 interface for RRC related changes.

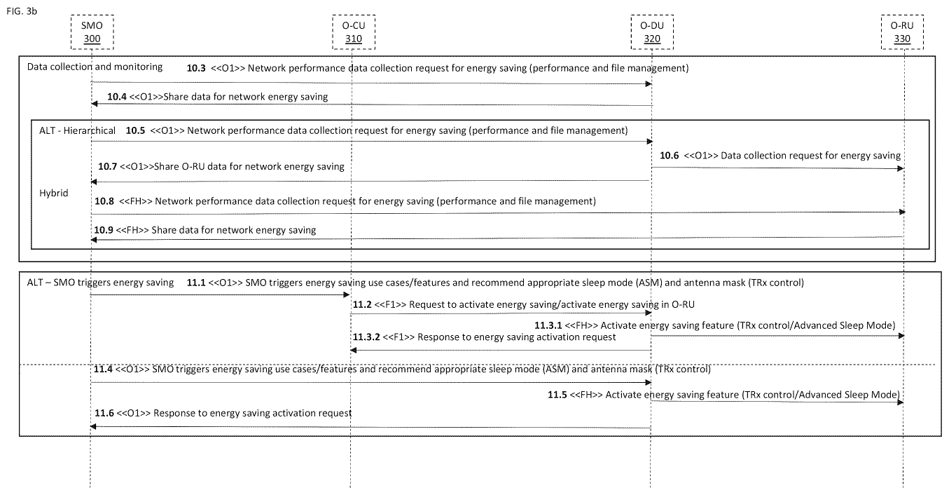

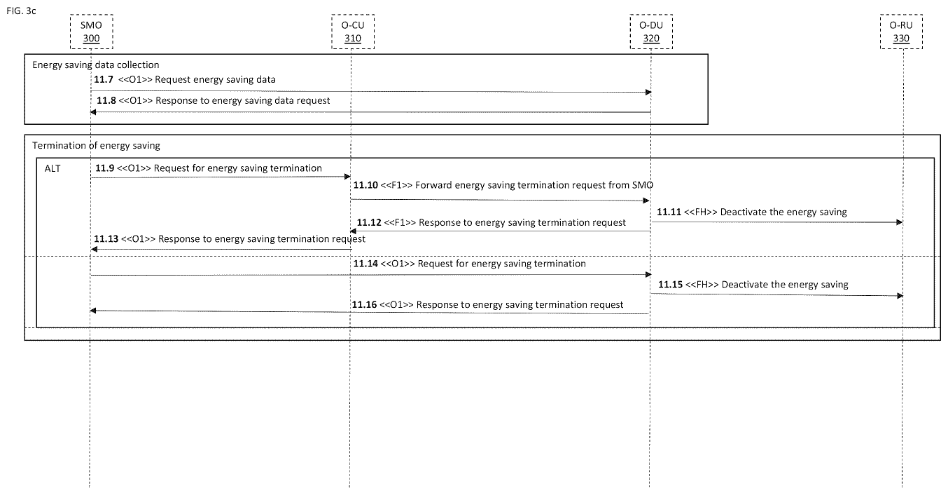

FIG. 3A-3C illustrates a general call flow diagram for network energy saving (NES) according to an embodiment. In particular, SMO 300, O-CU 310, O-DU 320, and O-RU 330 may be provided, which may correspond to the similar entities described in FIG. 2 above.

Referring to FIG. 3A, O-RU 330's capability may firstly be exposed. Constituent steps in the callflow are described as follows.
1—SMO 300 may request O-RU 330's supported features from O-DU 320 using a get rpc call for oru-feature over an O1 interface.
2—O-DU 320 may request NES feature support (such as carrier/cell switch off/on, TRx control, and advanced sleep mode) using a get rpc call over FH interface from O-RU 330.
3—NES features requested in 2 are exposed from O-RU 330 to O-DU 320 in a response.
4—NES capability parameters may be requested by O-DU 320 from O-RU 330 over FH interface. Sub-steps for exposing NES capability parameters may include (depending on the specific use-case):
4.1—Carrier/Cell Switch On/Off capability may be exposed via M-Plane in FH interface by O-RU 330 to O-DU 320;
4.2—List of supported TRx control antenna configurations may be exposed via M-Plane in FH interface by O-RU 330 to O-DU 320;
4.3—List of supported sleep modes may be exposed via M-Plane in FH by O-RU 330 to O-DU 320; and
4.4—Support of ST4 C-Plane messages and associated parameters (e.g., for TRx control and ASM use-cases, command scope etc.) may be exposed via M-Plane in FH by O-RU 330 to O-DU 320
5—O-DU 320 may forward the O-DU supported NES features and required configurations/parameters back to SMO 300.

Following steps 1-5 illustrated in FIG. 3A, O-DU capability may be exposed as follows.
6—O-DU supported features may be requested by SMO 300 from O-DU 320 over a get rpc call for odu-feature over O1 interface.
7—O-DU 320 may expose the NES supported features (for TRx and ASM use-cases) over O1 interface.
8—O-DU capability may be requested by SMO 300 from O-DU 320 over a get rpc call for odu-capability over O1 interface.
9—NES capability parameters may be exposed by O-DU 320 to SMO 300 over O1 interface.

Following steps 6-9 illustrated in FIG. 3A, data collection and monitoring may take place for SMO 300 (as illustrated in FIG. 3A-3B)
10.1—A request for network performance data collection for energy saving (Performance and file management) may be requested by SMO 300 from O-CU 310 over O1 interface.
10.2—The measured network data requested in 10.1 may be shared by O-CU 310 to SMO 300 over the O1 interface.
10.3—A request for network performance data collection for energy saving (Performance and file management) may be requested by SMO 300 from O-DU 320 over O1 interface.
10.4—The measured network data requested in 10.3 may be shared by O-DU 320 to SMO 300 over the O1 interface.

In the case of hierarchical deployment, network data from O-RU for energy saving may be obtained as follows (illustrated in FIG. 3B).
10.5—A request for network performance data collection for energy saving (Performance and file management) may be requested by SMO 300 from O-DU 320 over O1 interface.
10.6—Data collection request for energy saving is sent to O-RU 330.
10.7—The measured network data (which is the O-RU data for network energy saving in 10.6) may be shared by O-DU 320 to SMO 300 over the O1 interface.

Alternatively, if the deployment is instead a hybrid deployment, an alternative call flow to steps 10.5 through 10.7 is as follows:
10.8—Network performance data collection request for energy saving (performance and file management) is sent from SMO 300 directly to O-RU 330 over FH interface.
10.9—O-RU 330 shares the data for network energy saving requested in step 10.8 to SMO 300 over FH interface.

The SMO 300 may decide to trigger energy saving based on the network energy saving data collected in steps above. Accordingly, in a first case, the SMO 300 may communicate with O-CU to trigger the NES use-case as follows:
11.1—SMO 300 triggers NES use-case/features and recommends appropriate sleep mode (ASM) and antenna mask (TRx control) and sends trigger to O-CU 310 over O1 interface.
11.2—O-CU 310 requests O-DU 320 to activate energy saving/activate energy saving in O-RU 330 over F1 interface.
11.3.1—O-DU 320 instructs O-RU 330 to activate the energy saving feature (either TRx control or ASM) over FH interface.
11.3.2—Response to energy saving activation request is sent by O-DU 320 to O-CU 310 over F1 interface.

In the second case, SMO 300 may trigger the NES use-case with O-DU 320. Steps may be as follows:
11.4—SMO 300 triggers NES use-case/features and recommends appropriate sleep mode (ASM) and antenna mask (TRx control) to O-DU 320 over O1 interface.
11.5—Energy saving features are activated (TRx control/ASM) based on request sent from O-DU 320 to O-RU 330 over FH interface.
11.6—Response to energy saving activation request is sent by O-DU 320 to SMO 300 over O1 interface.

Referring now to FIG. 3C, energy saving data collection may be performed by SMO 300 in order to monitor the status of the energy saving from NES use-case implementation.

At step 11.7, SMO 300 requests energy saving data from o-DU 320 over O1 interface.

At step 11.8, a response to energy saving data request is sent by O-DU 320 to SMO 300 over O1 interface.

SMO 300 may determine based on the energy saving data received in step 11.8 that energy saving should be terminated. In a first case, the request may be sent to O-CU 310 by SMO 300, steps as follows:

At step 11.9, a request for energy saving termination may be sent from SMO 300 to O-CU 310 over O1 interface.

At step 11.10 the energy saving termination request is forwarded by O-CU 310 to O-Du 320 over F1 interface.

At step 11.11, the energy saving deactivation request is sent by O-Du 320 to O-RU 330 over FH interface.

At step 11.12, a response to energy saving termination request is sent from O-DU 320 to O-CU 310 over F1 interface.

At step 11.13, the response to the energy saving termination request is received by SMO 300 from O-CU 310 over O1 interface.

In the second case, the request for energy saving termination request is sent directly to O-DU 320 from SMO 300. Steps are as follows:

At step 11.14, the request for energy saving termination request is sent by SMO 300 to O-DU 320 over O1 interface.

At step 11.15, the request to deactivate energy saving is sent by O-DU 320 to O-RU 330 over FH interface.

At step 11.16, the response to energy saving termination request is sent by O-Du 320 to SMO 300 over O1 interface.

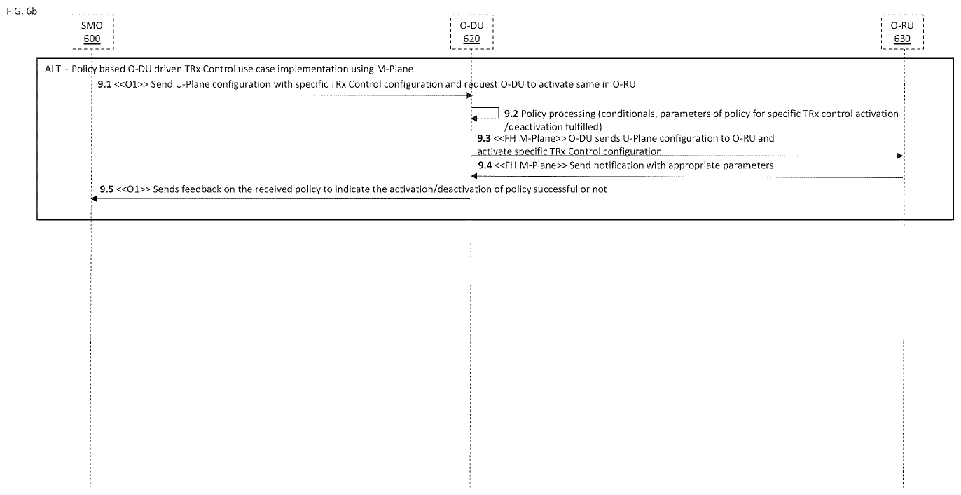

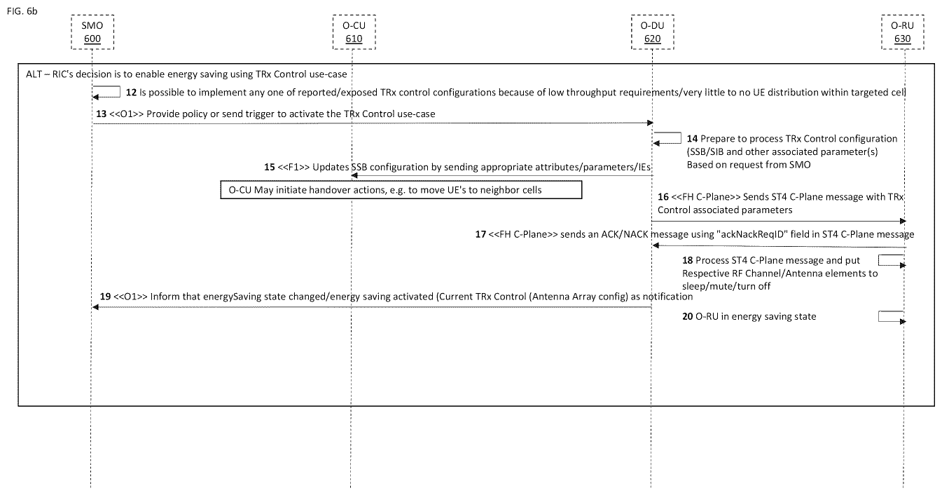

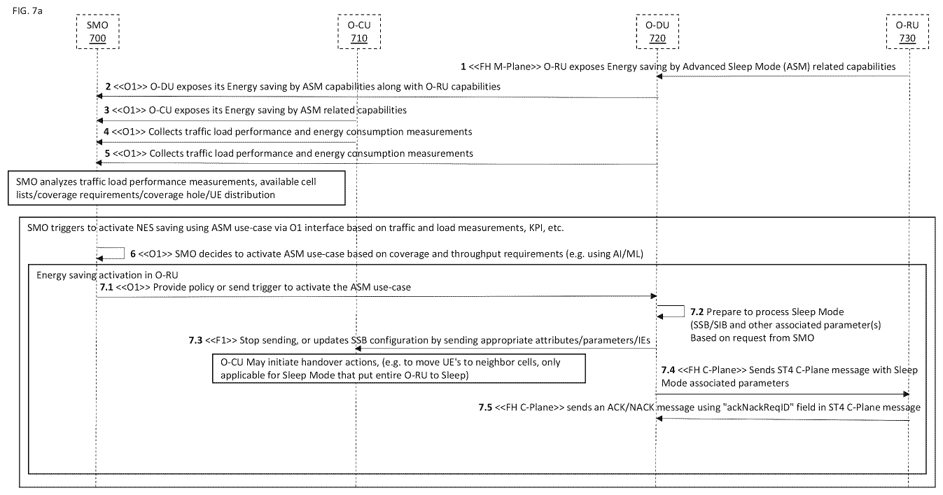

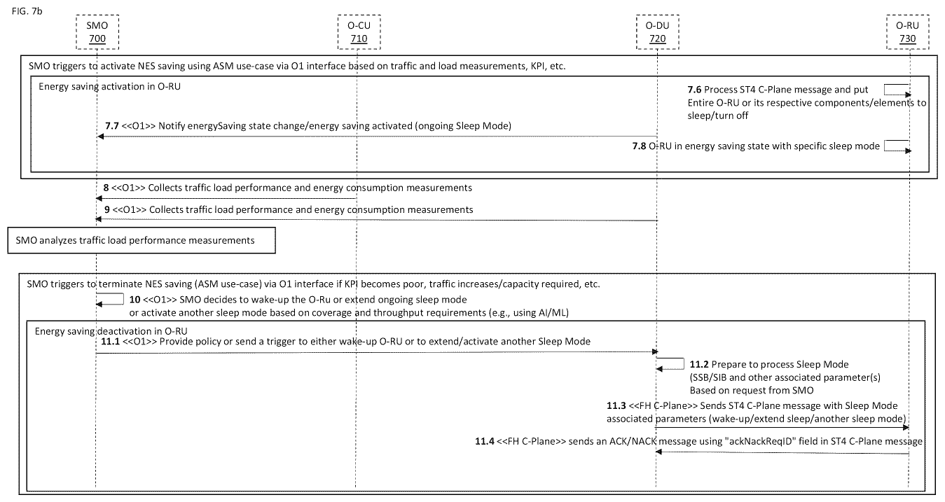

It should be appreciated that FIG. 3 is a more generalized call flow diagram and intended to cover multiple use-cases, and more specific call flow for the specific use-cases are discussed in FIG. 4—FIG. 7 as discussed below.

FIG. 4A-4C illustrates a call flow diagram for Carrier and Cell Switch Off/On network energy saving according to an embodiment. SMO 400, O-CU 410, O-DU 420, and O-RU 430 are provided, and may be similar to their counterparts above.

At step 1, the O-RU 430 may expose energy saving capabilities (e.g., NES related information) including carrier and cell switch off/on related capabilities to O-DU 420, over FH M-Plane interface.

At step 2, the O-DU 420 may expose its energy saving by carrier and cell switch off/on related capabilities along with O-RU capabilities to SMO 400 over O1 interface.

At step 3, the O-CU 410 may expose its energy saving by carrier and cell switch off/on related capabilities to SMO 400 over O1 interface.

At step 4, SMO 400 may collect traffic load performance and energy consumption measurements from O-CU 410 over O1 interface.

At step 5, SMO 400 may collect traffic load performance and energy consumption measurements from O-DU 420 over O1 interface.

Thereafter, SMO 400 may analyze traffic load performance measurements, available cell lists/coverage requirements/coverage hole/UE distribution in order to determine whether or not to activate an NES use-case.

At step 6, the SMO 400 may decide to trigger to activate NES using the carrier and cell switch off/on via the O1 interface (based on traffic and load measurements, Key Performance Indicator (KPI), etc.) over O1 interface. This may also be based on coverage and throughput requirements, and determined, for example, using artificial intelligence/machine learning (AI/ML).

Energy saving activation may be performed in O-RU 430 as follows.

At step 7.1, SMO 400 may send a trigger to O-CU 410 to activate carrier and cell switch off/on use-case over O1 interface. O-CU 410 may decide to initiate handover actions (for example, moving a UE to a neighbor cell in view of the cell switch off).

At step 7.2, O-CU 410 may forward the request to deactivate/shutdown cell(s) and associated carrier(s) by sending appropriate attributes/parameters/controls to O-DU 420 over F1 interface.

At step 7.3, O-DU 420 may prepare to process carrier and cell switch off based on request from SMO 400 through O-CU 410.

At step 7.4, O-DU 420 may send a edit-rpc call to O-RU 430 to begin carrier and cell switch off: e.g., <edit-rpc> <[tr]x-array-carrier:active->INACTIVE>

Referring now to FIG. 4B, at step 7.5, O-RU 430 may set [tr]x-array-carrier:state->DISABLED.

At step 7.6, O-RU 430 may be in an energy saving state.

At step 7.7, O-DU 420 may send an update to O-CU 410 over the F1 interface to indicate cell(s)/carrier(s) are turned off/powered off.

At step 7.8, O-DU 420 may inform SMO 400 that energy saving state has changed/energy saving activated (e.g., carrier and cell switched are powered off) as a notification over O1 interface.

At step 8, SMO 400 may collect traffic load performance and energy consumption measurements from O-CU 410 over O1 interface.

At step 9, SMO 400 may collect traffic load performance and energy consumption measurements from O-Du 420 over O1 interface.

The SMO 400 may analyze traffic load performance measurements. At step 10, the SMO may decide to deactivate carrier and cell switch off/on use-case based on coverage and throughput requirements (e.g., using AI/ML), for example, based on KPI being too poor, traffic increasing, capacity being required, etc. This may be performed over O1 interface.

At step 11.1, energy saving deactivation in O-RU may be triggered by SMO 400 and sent to O-CU 410 over O1 interface to deactivate the carrier and cell switch off/on use-case.

At step 11.2, a request to reactivate/turn on cell(s) and associated carrier(s) by sending appropriate attributes/parameters/control is sent from O-CU 410 to O-DU 420 over F1 interface.

At step 11.3, the O-Du 420 may prepare to process carrier and cell switch on based on request sent from SMO 400 through O-CU 410.

At step 11.4, the O-DU 420 may begin carrier and cell switch on by sending an edit rpc call to O-RU 430 over FH M-Plane interface, that is, <edit-rpc> <[tr]x-array-carrier:active->ACTIVE>

At step 11.5, O-RU 430 may sent [tr]x-array-carrier:state->Ready.

At step 11.6, O-RU 430 may be back to normal operation.

At step 11.7, O-DU 420 may send an update to O-CU 410 over F1 interface to indicate that cell(s)/carrier(s) are turned on/powered on. O-CU 410 may thereafter start accepting handover requests from UE(s) in neighbor cells.

At step 11.8, O-DU 420 may send a notification to SMO 400 over O1 interface to inform that energySaving state changed/energy saving is deactivated (carrier and cell switched/powered on).

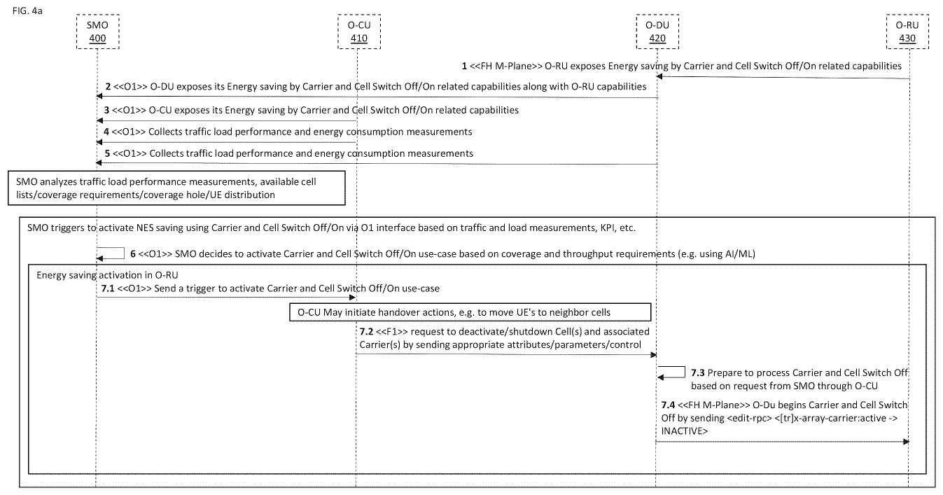

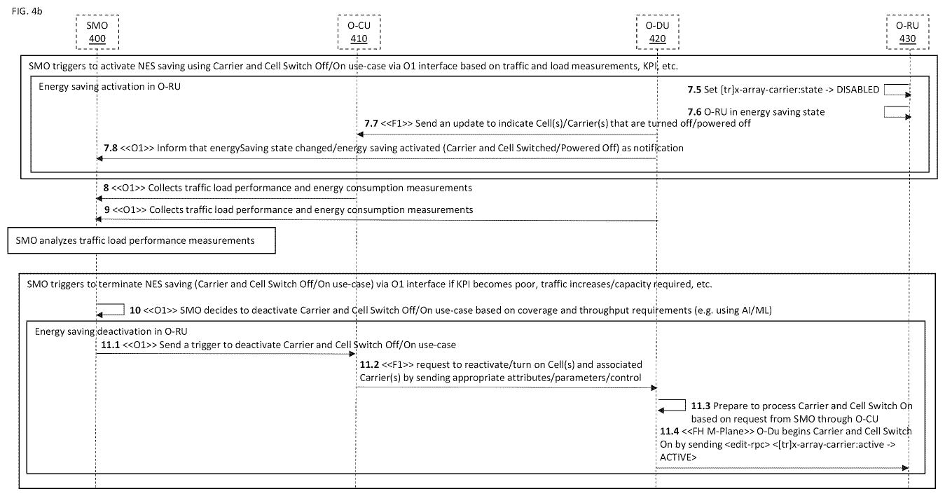

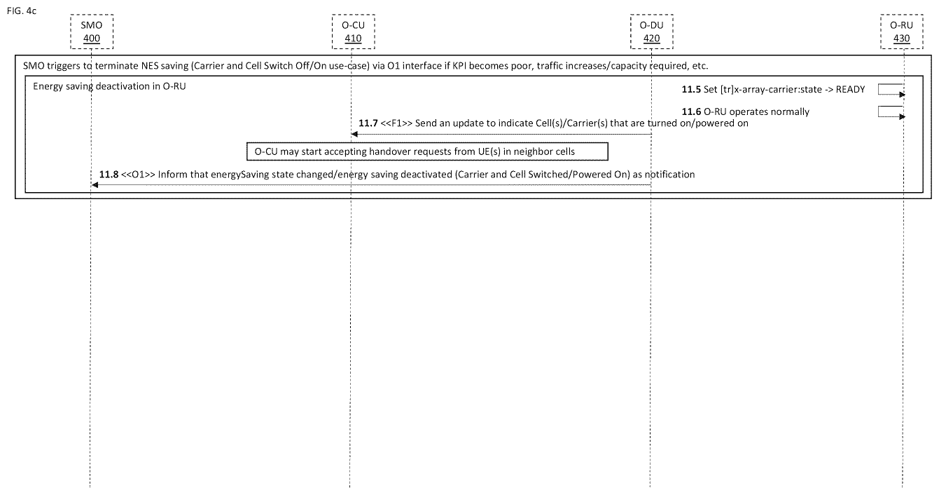

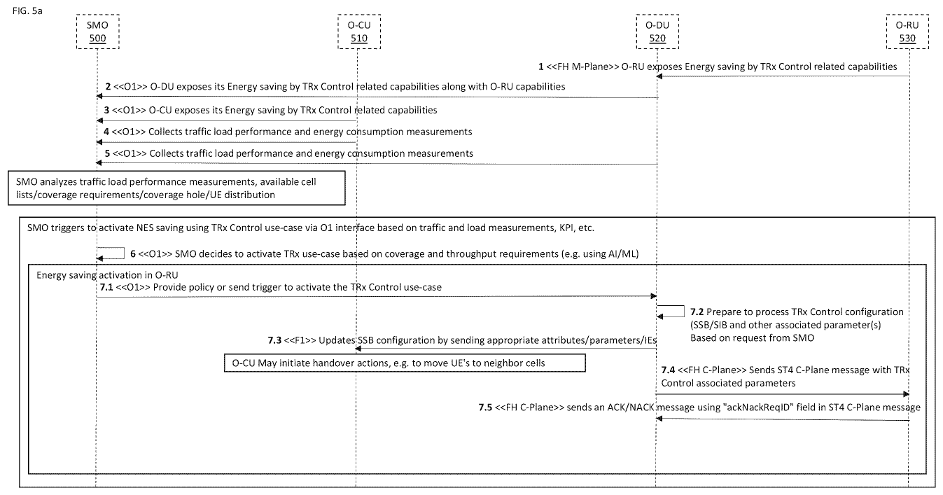

FIG. 5A-5C illustrates a call flow diagram for TRx network energy saving according to an embodiment.

SMO 500, O-CU 510, O-DU 520, and O-RU 530 are provided, and may be similar to their counterparts above.

At step 1, the O-RU 530 may expose energy saving capabilities (e.g., NES related information) including TRx control related capabilities to O-DU 520, over FH M-Plane interface.

At step 2, the O-DU 520 may expose its energy saving by TRx control related capabilities along with O-RU capabilities to SMO 500 over O1 interface.

At step 3, the O-CU 510 may expose its energy saving by TRx control related capabilities to SMO 500 over O1 interface.

At step 4, SMO 500 may collect traffic load performance and energy consumption measurements from O-CU 510 over O1 interface.

At step 5, SMO 500 may collect traffic load performance and energy consumption measurements from O-DU 520 over O1 interface.

Thereafter, SMO 500 may analyze traffic load performance measurements, available cell lists/coverage requirements/coverage hole/UE distribution in order to determine whether or not to activate an NES use-case.

At step 6, the SMO 500 may decide to trigger to activate NES using TRx control via the O1 interface (based on traffic and load measurements, Key Performance Indicator (KPI), etc.) over O1 interface. This may also be based on coverage and throughput requirements, and determined, for example, using artificial intelligence/machine learning (AI/ML).

Energy saving activation may be performed in O-RU 530 as follows.

At step 7.1, SMO 500 may provide a policy, or send a trigger to O-CU 510 to activate TRx control use-case over O1 interface.

At step 7.2, O-DU 520 may prepare to process TRx control configurations (synchronization signal block/system information block) (SSB/SIB) and other associated parameters based on the request from SMO 500.

At step 7.3, O-DU 520 may send an update of the SSB configuration to O-CU 510 over F1 interface by sending appropriate parameters/attributes/information elements (IE)'s. O-CU 510 may initiate handover actions (e.g., move UE's to neighbor cells).

At step 7.4, O-DU 520 may send a ST4 C-Plane message with TRx control associated parameters to O-DU 530 over FH C-Plane interface.

At step 7.5, O-RU 530 may send an ACK/NACK message using “ackNackReqID” field in the ST4 C-Plane message over FH C-Plane Interface to O-DU 520.

Referring now to FIG. 5B, at step 7.6 O-RU 530 may process ST4 C-Plane message from and put the respective RF channel/Antenna elements to sleep/mute/turn off.

At step 7.7, O-DU 520 may inform SMO 500 that energy saving state changed/energy saving activated (Current TRx control/antenna array configuration) as a notification over O1 interface.

At step 7.8, O-RU 530 may be in an energy saving state.

At step 8, SMO 500 may collect traffic load performance and energy consumption measurements from O-CU 510 over O1 interface.

At step 9, SMO 500 may collect traffic load performance and energy consumption measurements from O-DU 520 over O1 interface.

The SMO 500 may analyze traffic load performance measurements. At step 10, the SMO 500 may decide to move to baseline antenna array configuration or activate another TRx control (Antenna array) configuration based on coverage and throughput requirements (e.g., using AI/ML), for example, based on KPI being too poor, traffic increasing, capacity being required, etc. This may be performed over O1 interface.

At step 11.1, SMO 500 may provide a policy or send a trigger to O-DU 520 over O1 interface to activate another TRx control configuration or move to the baseline antenna array configuration.

At step 11.2, O-DU 520 may prepare to process TRx control configuration (SSB/SIB and other associated parameters(s) based on the request from SMO in step 11.1.

At step 11.3, O-DU 520 may send a ST4 C-Plane message with TRx control associated parameters to O-RU 520 over FH C-Plane interface.

At step 11.4, O-RU 530 may send an ACK/NACK message using “ackNackReqID’ field in ST4 C-Plane message.

Referring now to FIG. 5C, at step 11.5, O-RU 530 may process the ST4 C-Plane message from 11.3 and either wake-up O-RU 530 or put the respective RF channel/antenna elements to turn on/unsleep/unmute.

At step 11.6, a ST8 “ready” message may be sent from O-RU 530 to O-DU 520 in case of non-guaranteed wake-up duration over FH C-Plane. Interface.

At step 11.7, O-DU 520 may send an emergency wake-up to O-RU 530 over FH M-Plane interface to interrupt sleep in case CU plane processing unit is turned off as part of sleep.

At step 11.8, O-RU 530 may send a notification to O-DU 520 over FH M-Plane interface in case of emergency wake-up request.

At step 11.9, the O-RU 530 may operate normally or enter to another TRx Control configuration and/or sleep mode.

At step 11.10, O-DU 520 updates the SSB configuration at O-CU 510 by sending appropriate attributes/parameters/IE's over F1 interface.

At step 11.11, O-DU 520 may inform SMO 500 over O1 interface notification that energy saving state changed (e.g., O-RU 530 woke-up, or ongoing TRx Control (Antenna Array) configuration).

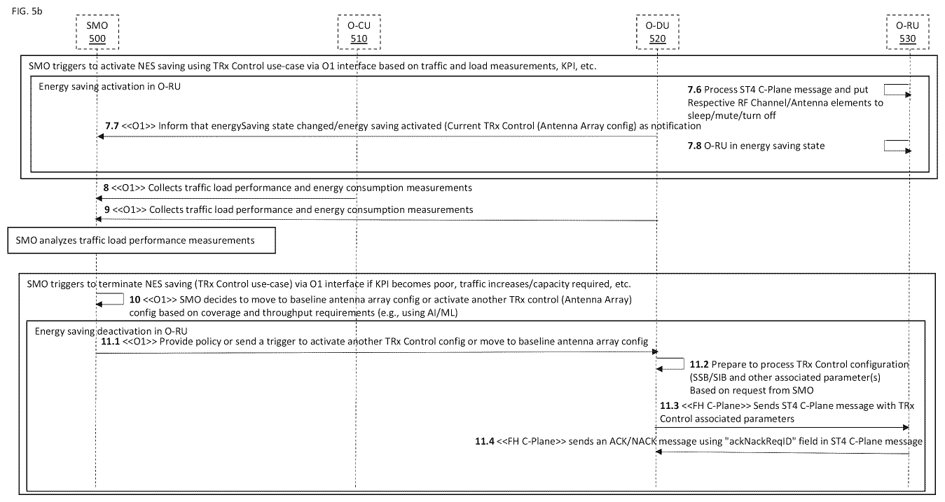

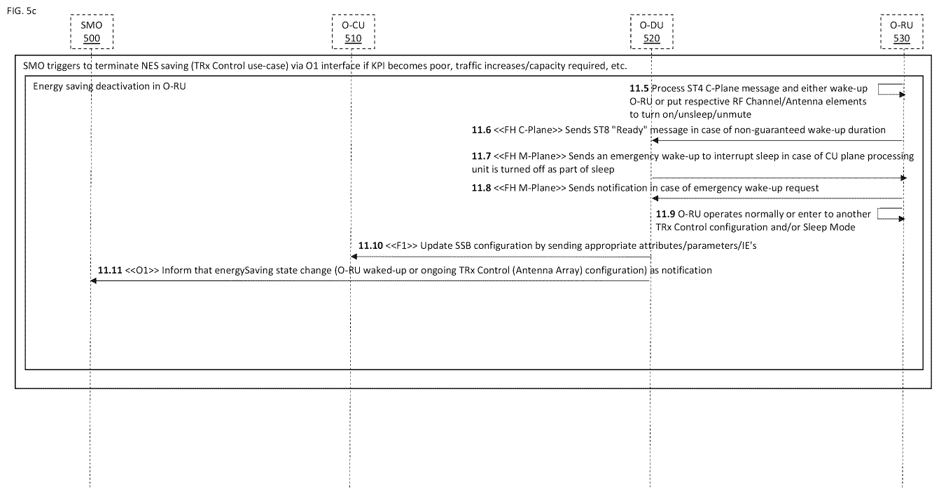

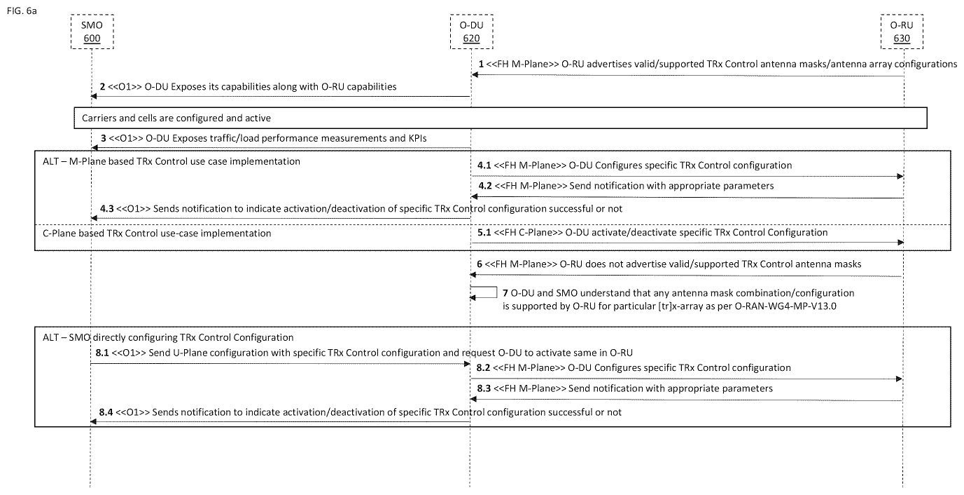

FIG. 6A-6B illustrates a call flow diagram for TRx Control Implementation by SMO/O-DU direct control or O-DU driven based on policy according to an embodiment. SMO 600, O-DU 620, and O-RU 630 are provided, and may be similar to their counterparts above.

Referring to FIG. 6A, at step 1, O-RU 630 may advertise valid/supported TRx Control antenna masks/antenna array configurations to O-DU 620 over a FH M-Plane.

At step 2, O-DU 620 may expose its capabilities along with O-RU capabilities to SMO 600 over O1 interface.

Carriers and cells may become configured and active. At step 3, O-DU 620 exposes traffic/load performance measurements and KPI's to SMO 600.

In a first sub-case, M-plane based TRx Control use-case implementation may be applied.

At step 4.1, O-DU 620 may configure a specific TRx Control configuration at O-RU 630 over a FH M-Plane interface.

At step 4.2, O-RU 630 may send a notification with appropriate parameters to O-DU 620.

At step 4.3, O-DU 620 may send a notification to SMO 600 to indicate whether activation/deactivation of specific TRx Control configuration was successful or not over O1 interface.

In a second sub-case, C-plane based TRx Control use-case may be applied. At step 5.1, O-DU 620 activates/deactivates a specific TRx control configuration.

In another alternate case, O-RU 630 does not advertise valid/supported TRx Control antenna masks in step 6 (over the FH M-Plane interface).

Accordingly, in step 7, the O-DU 620 and SMO 600 may recognize that any antenna mask combination/configuration is supported by O-Ru for particular [tr]x-array as per O-RAN-WG4-MP-V13.0.

Two more further sub-cases may be applied, firstly, a SMO 600 may directly configure TRx Control Configuration. At step 8.1, a u-plane configuration may be sent from SMO 600 to O-DU 620 to request O-DU 620 to activate the same in O-RU 630, over O1 interface

At step 8.2, O-DU 620 configures the specific TRx control configuration in O-RU 630 over FH M-Plane.

At step 8.3, O-RU 630 sends a notification with appropriate parameters to O-DU 620 over FH M-Plane interface.

At step 8.4, O-Du 620 sends a notification to SMO 600 to indicate whether activation/deactivation of specific TRx Control configuration is successful or not.

Referring now to FIG. 6 B, in a second sub-case, policy-based O-DU driven TRx Control use-case implementation using M-Plane may be applied. At step 9.1, a u-plane configuration with a specific TRx control configuration may be sent by SMO 600 and requested to the O-DU 620 to activate the same in O-RU 630 over O1 interface.

At step 9.2, policy processing may be performed by the O-Du 620 (e.g., conditionals, parameters of policy for specific TRx control activation/deactivation fulfilled).

At step 9.3, O-DU 620 may send a U-plane configuration to O-RU 630 over FH M-plane interface.

At step 9.4, O-Ru 630 may send a notification with appropriate parameters to O-DU 620 over FH M-Plane interface.

At step 9.5, O-DU may send feedback to SMO 600 based on the received policy to indicate whether the activation/deactivation of policy successful or not. FIG. 7A-7C illustrates a call flow diagram for advanced sleep mode (ASM) network energy saving according to an embodiment. SMO 700, O-CU 710, O-DU 720, and O-RU 730 are provided, and may be similar to their counterparts above.

At step 1, O-RU 730 may expose energy saving by ASM related capabilities to O-DU 720 over FH M-Plane interface.

At step 2, O-DU 720 may expose its energy saving by ASM capabilities along with O-RU capabilities to SMO 700 over O1 interface.

At step 3, O-CU 710 may expose its energy saving by ASM related capabilities to SMo 700 over O1 interface.

At step 4, SMO 700 may collect traffic load performance and energy consumption measurements from O-CU 710 over O1 interface.

At step 5, SMO 700 may collect traffic load performance and energy consumption measurements from O-Du 720 over O1 interface.

The SMO 700 may analyze traffic load performance measurements, available cell lists/coverage requirements/coverage hole/UE distribution. At step 6, SMO 700 may decide to activate ASM use-case based on coverage and throughput requirements (e.g., using AI/ML) over O1 interface (for example, based on traffic and load measurements, KPI, etc.)

At step 7.1, SMO 700 may provide a policy or send a trigger to O-DU 720 over O1 interface to activate the ASM use-case.

At step 7.2, O-DU 720 may prepare to process sleep mode (SSB/SIB and other associated parameter(s) based on the request from the SMO 700.

At step 7.3, O-DU 720 may either stop sending to O-CU 710 over F1 interface, or update a SSB configuration at O-CU 710 over F1 interface by sending appropriate attributes/parameters/IE's. O-Cu 710 may initiate handover actions (e.g., to move UE's to neighbor cells, only applicable for Sleep Mode which puts entire O-RU 730 to Sleep).

At step 7.4, O-DU 720 may send a ST4 C-Plane message with Sleep Mode associated parameters to O-RU over FH C-Plane interface.

At step 7.5, O-DU 720 sends an ACK/NACK message using “ackNackReqID” field in ST4 C-Plane message to O-RU 730 over FH C-Plane interface.

Referring now to FIG. 7B, at step 7.6, O-RU 730 may process the ST4 C-Plane message from step 7.4, and put the entire O-Ru or its respective components/elements to sleep/turn off.

At step 7.7, O-DU 720 may notify SMO 700 over O1 interface that energySaving state changed/energy saving activated (ongoing Sleep Mode).

At step 8, SMO 700 collects traffic load performance and energy consumption measurements from O-CU 710 over O1 interface.

At step 9, SMO 700 collects traffic load performance and energy consumption measurements from O-DU 720 over O1 interface.

SMO 700 may analyze the load performance measurements received in steps 8 and 9, and decide in step 10 to terminate NES saving over O1 interface. Particularly, SMO 700 may decide to wake up O-RU 730 or extend the ongoing sleep mode, or activate another sleep mode based on coverage and throughput requirements (e.g., using AI/ML), for example,e, based on KPI becoming poor, traffic increasing/capacity required.

At step 11.1, energy saving deactivating may be initiated by SMO 700 by providing a policy or sending a trigger to O-DU 720 to either wake-up O-RU 730 or extend/activate another Sleep Mode over O1 interface.

At step 11.2, O-DU 720 may prepare to process sleep mode (SSB/SIB and other associated parameter(s) based on request from SMO 700.

At step 11.3, O-DU 720 sends a ST4 C-Plane message with Sleep Mode associated parameters (wake-up/extend sleep/another sleep mode) to O-RU 730 over FH C-Plane interface.

At step 11.4, O-RU 730 sends an ACK/NACK message using “ackNackReqID” field in ST4 C-Plane message over FH C-Plane interface.

Referring now to FIG. 7C, at step 11.5, O-RU 730 may process the ST4 C-Plane message from step 11.3 and either wake-up the O-RU 730 or put respective components into the appropriate sleep mode.

At step 11.6, a ST8 “ready” message may be sent from O-RU 730 to O-DU 720 in case of non-guaranteed wake-up duration over FH C-Plane. Interface.

At step 11.7, O-DU 720 may send an emergency wake-up to O-RU 730 over FH M-Plane interface to interrupt sleep in case CU plane processing unit is turned off as part of sleep.

At step 11.8, O-RU 730 may send a notification to O-DU 720 over FH M-Plane interface in case of emergency wake-up request.

At step 11.9, the O-RU 730 may operate normally or enter to another TRx Control configuration and/or sleep mode.

At step 11.10, O-DU 720 may prepare or stop or updates the SSB configuration at O-CU 710 by sending appropriate attributes/parameters/IE's over F1 interface. O-CU 710 may start accepting handover requests from UE's in neighbor cells (only applicable for sleep mode which puts entire O-RU to sleep).

At step 11.11, O-DU 720 may inform SMO 700 over O1 interface notification that energy saving state changed (e.g., O-RU 730 woke-up, or ongoing sleep mode extended or in another sleep mode).

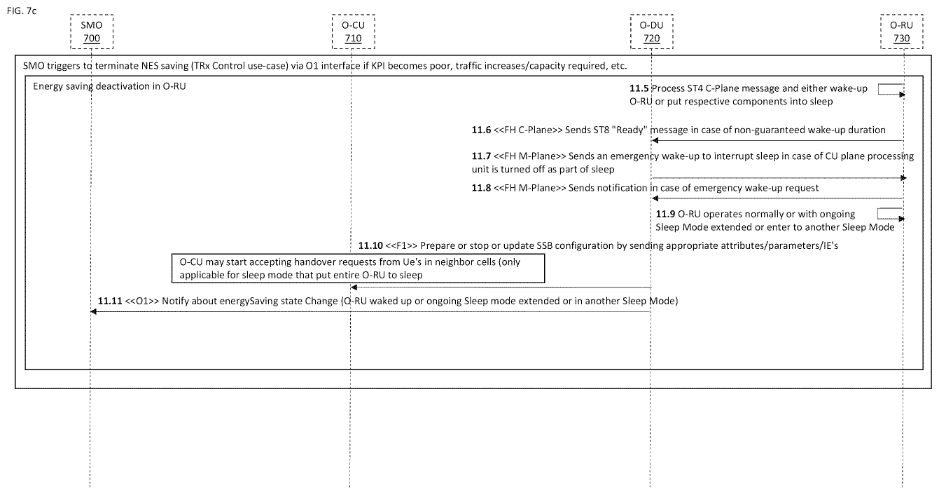

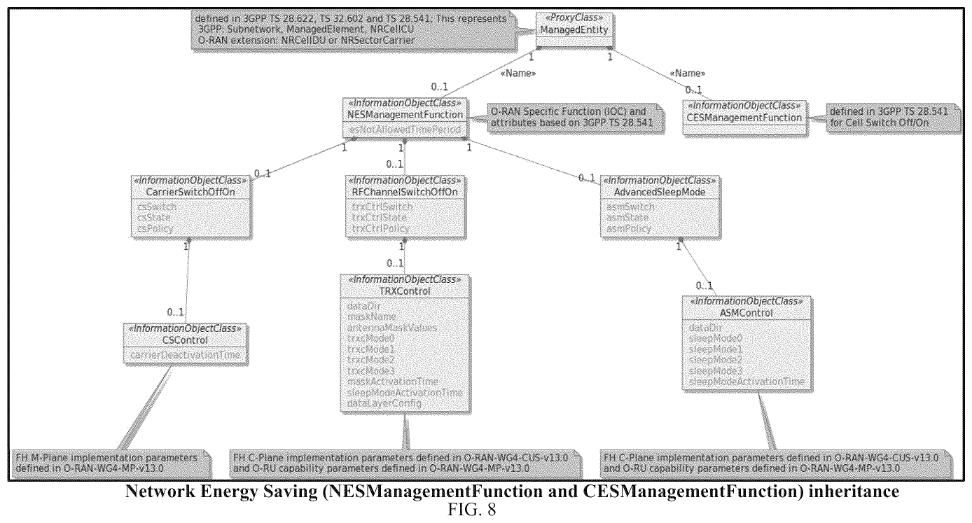

FIG. 8 is a block diagram of an example data structure for gNB-DU(O-DU)/gNB-CU(O-CU) IM/DM to support Network Energy Saving according to an embodiment. In some embodiments, gNB-DU(O-DU)/gNB-CU(O-CU) IM/DM may be configured to support Network Energy Saving by NESManagementFunction and CESManagementFunction inheritance. FIG. 8 illustrates examples of various instances of network energy saving using NES management function containment.

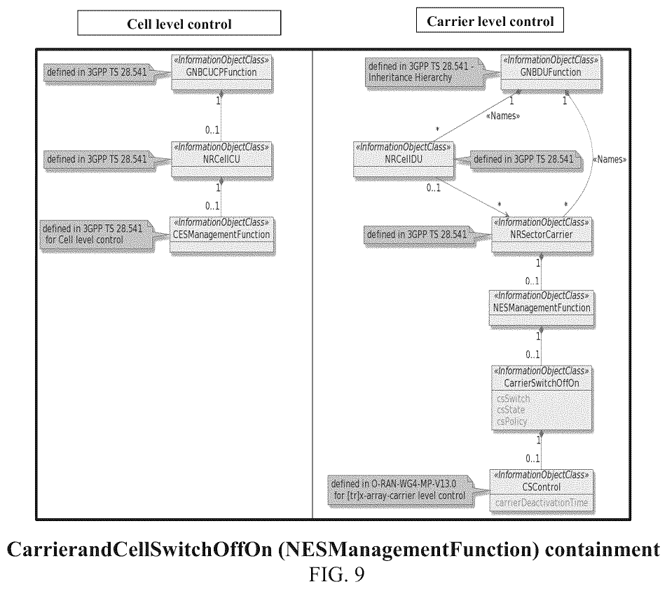

FIG. 9 is a block diagram of an example data structure for O-DU network energy saving according to an embodiment. According to embodiments, network energy saving may be done using a carrier switch off or on use case object. As illustrated in FIG. 9, in case of CESManagementFunction defined in 3GPP, the CESManagementFunction may be reused to configure cell using O-CU. Whereas in an O-RAN specific IOC “NESManagementFunction”, the NESManagementFunction may be contained in an 3GPP “NRSectorCarrier” for providing an SMO to enable or disable carrier in O-RU. According to embodiments, this enabling or disabling carrier in O-RU may be done using an attribute “carrierActivationTime”. However, in the case of O-RU, [tr]x-arrays may be mapped with may be mapped with [tr]x-array-carriers and then may be mapped with 3GPP objects NRSectorCarrier and NRCellDU. For enabling or disabling the [tr]x-array-carriers in the O-RU, “CarrierSwitchOffOn” use case object may be utilized with attributes “csSwitch”, “csState”, “csControl” and “csPolicy” that are contained in the NESManagementFunction.

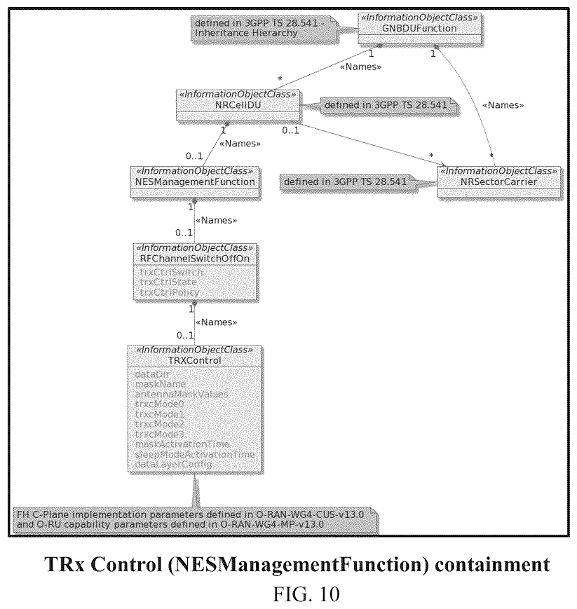

FIG. 10 is a block diagram of an example data structure for O-DU network energy saving using TRx control according to an embodiment. Referring to FIG. 10, the network energy saving may be done using a TRx control use case object. In some instances, cells may be impacted, then in such instances, the “NESManagementFunction” may be contained under “NRCellDU”. The “NESManagementFunction” may include an “RFChannelSwitchOffOn” with attributes “trxCtrlSwitch”, “trxCtrlState”, “trxCtrlPolicy”, and “dataLayerControl”. The “RFChannelSwitchOffOn” may include a sub use case object of TRx Control with attributes such as, but not limited to, a list of supported TRx Control configurations (antenna mask values) and associated sleep modes.

FIG. 11 is a block diagram of an example data structure for O-DU network energy saving using Advanced Sleep Mode according to an embodiment. Cells that impacted the “NESManagementFunction” may be contained under “NRCellDU”. In such an instance, the “NESManagementFunction” may include an “AdvancedSleepMode” use case object with attributes such as, but not limited to, “asmSwitch”, “asmState”, and “asmPolicy”. The “AdvancedSleepMode” may include a child object “ASMControl” that may include attributes such as list of supported sleep modes, activation time, and data direction for the network energy saving

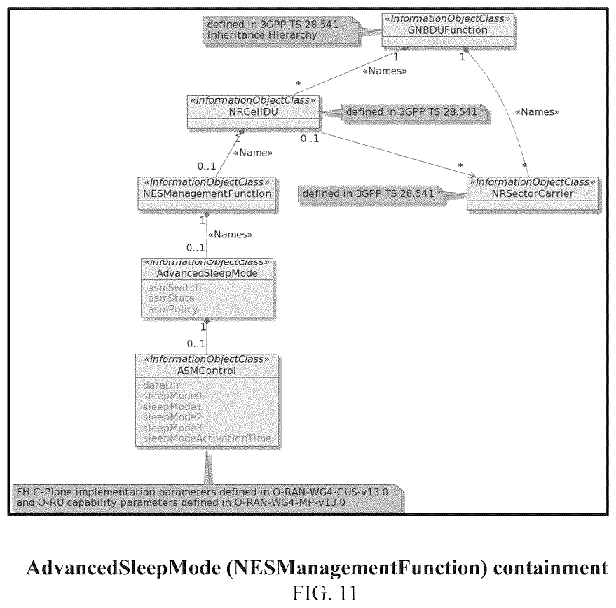

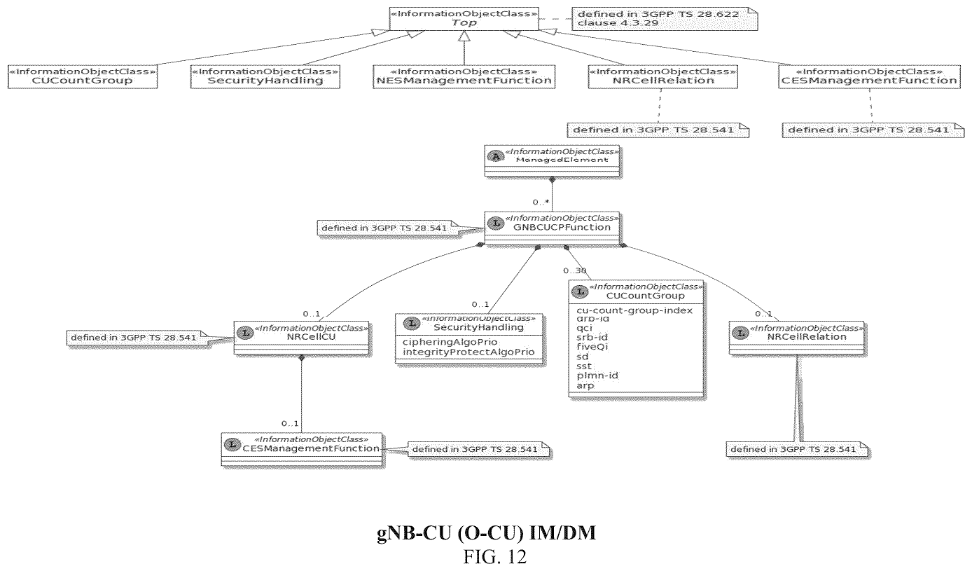

FIG. 12 is a block diagram of an example data structure for O-CU network energy saving according to an embodiment. FIG. 12 illustrates an high-level overview of network energy saving using gNB-CU (O-CU) IM/DM, In some embodiments, sub use cases may be defined under “NESManagementFunction” for the respective NES use case handling.

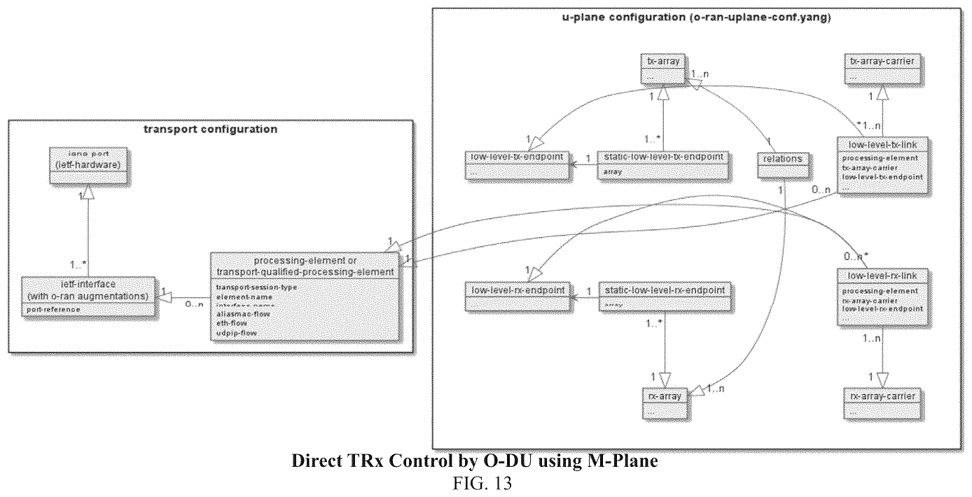

FIG. 13 is a block diagram of an example data structure for Direct TRx Control by O-DU using M-Plane according to an embodiment.

According to FIG. 13, the O-RU may advertise supported TRx Control masks using an o-ran-uplane-conf.yang module for O-RU Exposing Capability in a fronthaul M-Plane. There may be a list of TRx control configurations supported by the O-RU which may be reported with their corresponding mask-name and an antenna-mask. The absence of a list of supported-trx-control-masks may indicate that any combination of antenna mask may be supported by the O-RU for a particular [tr]x-array. In some instances, if the O-DU does not detect supported-trx-control-masks, then the O-DU may configure any mask or the O-DU may deactivate or activate any specific TRx path/antenna array element by not configuring or removing the low-level-[tr]x-links/low-level-[tr]x-endpoint. As shown in the FIG. 13 the O-DU may either configure or not configure specific low-level-[tr]x-link/low-level-[tr]x-endpoint that is associated to static-low-level-[tr]x-endpoint (TRx Path/Antenna Array), to provision TRx control. The low-level-[tr]x-links associated with [tr]x-array-carrier may be mapped to low-level-[tr]x-endpoint for direct TRx control.

It should be appreciated that the above-described data models in FIG. 8-13 are examples, and that differences in structure and variable names may be made by a person skilled in the art depending on the specific implementation use-case.

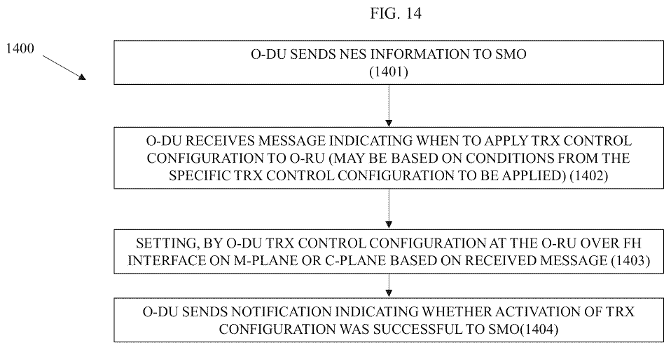

FIG. 14 is a flowchart diagram of an example method 1400 for Rx Control Implementation by SMO/O-DU direct control according to an embodiment.

At operation S1401, the O-DU may send NES information to the SMO. According to embodiments, network energy saving (NES) information may include at least one of network traffic, load performance measurements, and Key Performance Indicators (KPI's).

According to embodiments, the O-DU may receive from the O-RU, supported TRx Control antenna masks and antenna array configurations, wherein the NES information further comprises the supported TRx Control antenna masks and antenna array configurations, and wherein the O-DU and SMO are only allowed to set the TRx Control Configuration to include the supported TRx Control antenna masks and antenna array configurations.

According to embodiments, the NES information does not include an antenna mask or antenna array configuration, and the O-DU and SMO are allowed to set the TRx Control Configuration to use any antenna mask and antenna array configurations.

At operation S1402, the O-Du may receive a message indicating when to apply TRx control configuration to the O-RU. According to embodiments, the message comprises a U-plane configuration indicating a specific TRx Control configuration. According to other embodiments, the message may be a policy indicating a specific TRx Control configuration.

At operation S1403, the O-Du may set TRx configuration at the O-Ru over FH interface on M-plane or C-Plane based on received message from operation S1402. According to embodiments, if the message comprises a U-plane configuration, setting the TRx Control configuration comprises: applying, by the O-DU to the O-RU, the specific TRx Control configuration.

According to embodiments, if the message comprises a policy, setting the TRx configuration comprises: processing, by the O-DU, the policy to obtain parameters of the TRx Control configuration, applying, by the O-DU to the O-RU, the specific TRx Control configuration based on the obtained parameters.

At operation S1404, the O-DU may send a notification indicating whether activating the TRx configuration was successful or not.

According to embodiments, class definitions, the class definition(s) attributes and the class definition(s) constraints may be provided. Various class definitions are described:

CESManagementFunction IOC—The Information Object Class (IOC) may provide attribute(s) that may be required to configure cell(s) and to work with O-DU for configuring associated carriers for saving energy using cell and carrier switch off/on use case. The attribute and attribute constraint are defined as per 3GPP TS 28.541.

NESManagementFunction <<IOC>>—is O-RAN specific class and may provide attribute(s) that needed to configure O-DU to work with O-RU for energy saving feature implementation. The attribute(s) may include attributes inherited from ManagedEntity as defined in 3GPP TS 28.622, clause 4.3.20 and 3GPP TS 32.602, clause 6.3.2 as given in TABLE-1 A.

TABLE 1A

| | | isRead- | isWrit- | isIn- | |
|---|---|---|---|---|---|
| Attribute name | S | able | able | variant | isNotifyable |
| NESControl | CM | T | T | F | T |
| csSwitch | CM | T | T | F | T |
| csState | CM | T | T | F | T |
| trxCtrlSwitch | CM | T | T | F | T |
| trxCtrlState | CM | T | T | F | T |
| asmSwitch | CM | T | T | F | T |
| asmState | CM | T | T | F | T |
| esNotAl- | O | T | T | F | T |
| lowedTimePeriod | | | | | |

The attribute constraints for the NESManagementFunction is shown in TABLE-1B

TABLE 1B

| Name | Definition |
|---|---|
| NESControl CM | Condition: When O-Ru supports Network Energy Savings feature and |
| support qualifier | O-Ru is configured to work in one of the NES use cases, this |
| | parameter is mandatory |
| csSwitch | Condition: When O-RU supports Network Energy Savings feature |
| | and control (enable or disable) Carrier and Cell Switch Off/On use |
| | case in O-RU, this parameter is mandatory |
| csState | Condition: When is configured with Carrier and Cell Switch Off/On |
| | use case and to notify the activation or deactivation state of the use |
| | case, this parameter is mandatory. |
| trxCtrlSwitch | Condition: When O-Ru supports Network Energy Savings feature and |
| | control (enable or disable) TRx Control use case in O-RU, this |
| | parameter is mandatory. |
| trxCtrlState | Condition: When is configured with TRx Control use case and to |
| | notify the activation or deactivation state of the use case, this |
| | parameter is mandatory. |
| asmSwitch | Condition: When O-RU supports Network Energy Savings feature |
| | and control (enable or disable) Advanced Sleep Mode use case in O- |
| | RU this parameter is mandatory. |
| asmState | When is configured with Advanced Sleep Mode use case and to notify |
| | the activation or deactivation state of the use case, this parameter is |
| | mandatory. |

CarrerSwitchffOn<<IOC>>—This IOC may provide attributes that may be required to configure O-DU to work with O-RU for enabling or disabling the CarrierSwitchOffOn use case object. The attributes may be inherited from O-RAN specific NESManagementFunction IOC and may include the following attributes as shown in TABLE-2A and TABLE-2B

TABLE 2A

| Attribute | | | | | |
|---|---|---|---|---|---|
| name | S | isReadable | isWritable | isInvariant | isNotifyable |
| csSwitch | CM | T | T | F | T |
| csState | CM | T | T | F | T |
| csPolicy | CM | T | T | F | T |

TABLE 2B

| Attribute name | S | isReadable | isWritable | isInvariant | isNotifyable |
|---|---|---|---|---|---|
| csControl | CM | T | T | F | T |
| csPolicy | CM | T | T | F | T |

The attribute constraints may include the following as show in TABLE-3 A and TABLE 3-B

TABLE 3A

| Name | Definition |
|---|---|
| csSwitch CM support | Condition: When O-RU supports Carrier and Cell Swithc Off/On use |
| qualifier | case of Network Energy Saving feature. This parameter is |
| | mandatorily used to enable or disable that use case in O-DU. |
| csState CM support | Condition: When is configured with Carrier and Cell Switch Off/On |
| qualifier | use case and to notify the activation or deactivation state of the use |
| | case, this parameter is mandatory. |
| csPolicy CM support | Condition: when O-Ru supports Carrier and Cell Switch Off/On use |
| qualifier | case of a Network Energy Saving feature and O-Du to receive policy |
| | on when to activate or deactivate use case in O-RU, this parameter is |
| | mandatory |

TABLE 3B

| Name | Definition |
|---|---|
| csControl CM | Condition: When O-Ru supports Carrier and Cell Switch Off/On use |
| support qualifier | case of Network Energy Saving feature. This parameter is |
| | mandatorily used to control that use case in O-DU. |
| csPolicy CM support | Condition: When O-RU supports Carrier and Cell Switch Off/On use |
| qualifier. | case of Network Energy Saving feature and O-Du to receive policy |
| | on when to activate or deactivate use case in O-RU this parameter is |
| | mandatory. |

CSControl <<IOC>>—This IOC may provide attribute that may be needed to configure O-DU to work with O-RU for deactivation of carrier to achieve energy saving. The attribute may be inherited from O-RAN specific CarrierSwitchOffOn IOC and may contain the following attributes as shown in TABLE-4.

TABLE 4

| Attribute name | S | isReadable | isWritable | isInvariant | isNotifyable |
|---|---|---|---|---|---|
| carrierDe- | O | T | T | F | T |
| activationTime | | | | | |

RFChannelSwitchOffOn—This IOC may provide attribute(s) that may be needed to configure O-DU to work with O-RU for enabling or disabling TRx control sub use case for energy saving. The attributes may be inherited from NESManagementFunction IOC and may include the following attributes as shown in TABLE-5A and TABLE 5B.

TABLE 5A

| Attribute name | S | isReadable | isWritable | isInvariant | isNotifyable |
|---|---|---|---|---|---|
| trxCtrlSwitch | CM | T | T | F | T |
| trxCtrlState | CM | T | T | F | T |
| trxCtrlPolicy | CM | T | T | F | T |

TABLE 5B

| Attribute name | S | isReadable | isWritable | isInvariant | isNotifyable |
|---|---|---|---|---|---|
| trxControl | CM | T | T | F | T |
| dataLayerControl | CM | T | T | F | T |

The attribute constraints for RFChannelSwitchOffOn ARE shown in TABLE-6A and TABLE 6B

TABLE 6A

| Name | Definition |
|---|---|
| trxCtrlSwitch | Condition: When O-RU supports Network Energy |
| CM support | Savings feature and control (enable or disable) |
| qualifier | TRx Control use case in O-RU, this parameter |
| | is mandatory. |
| trxCtrlState | Condition: When is configured with TRx Control |
| CM support | use case and to notify the activation or |
| qualifier | deactivation state of the use case, this |
| | parameter is mandatory. |
| trxCtrlPolicy | Condition: when O-RU supports TRx Control sub |
| CM support | use case of a Network Energy Saving feature |
| qualifier | and O-RU is configured to activate or deactivate |
| | TRx control sub use case, this parameter is |
| | mandatory |

TABLE 6B

| Name | Definition |
|---|---|
| TRxControl | ConditionL When O-RU supports RF channel Switch |
| CM support | Off/On use case of Network energy saving features |
| qualifier | and O-RU is configured to activate or deactivate |
| | TRx control sub use case, this parameter is |
| | mandatory. |
| dataLayerControl | Condition: When O-RU supports RF Channel Switch |
| CM support | Off/On use case of Network energy saving feature |
| qualifier | and O-Ru is configured to activate or deactivate |
| | dataLayerControl wherever is applicable, this |
| | parameter is mandatory. |

TRXControl—This IOC may provide attribute that may be required to configure O-DU to work with O-RU for activating or deactivating specific TRXControl configuration with associated parameters for energy saving. In some embodiments, the TRXControl configuration may also be referred as antenna array configuration. The attributes may be inherited from RFChannelSwitchOffOn IOC and may include the following attributes as shown in TABLE-7 A and TABLE 7B

TABLE 7A

| Attribute name | S | isReadable | isWritable | isInvariant | isNotifyable |
|---|---|---|---|---|---|
| dataDir | CM | T | T | F | T |
| maskName | O | T | T | F | T |
| antennaMaskValues | O | T | T | F | T |
| trxcMode0 | O | T | T | F | T |
| trxcMode1 | O | T | T | F | T |
| trxcMode2 | O | T | T | F | T |
| trxcMode3 | O | T | T | F | T |
| MaskActivationTime | O | T | T | F | T |
| sleepModeActivationTime | O | T | T | F | T |
| dataLayerConfig | CM | T | T | F | T |

TABLE 7B

| Attribute name | S | isReadable | isWritable | isInvariant | isNotifyable |
|---|---|---|---|---|---|
| trxCtrlPolicy | CM | T | T | F | T |
| dataDir | CM | T | T | F | T |
| maskName | O | T | T | F | T |
| antennaMaskValues | O | T | T | F | T |
| trxcMode0 | O | T | T | F | T |
| trxcMode1 | O | T | T | F | T |
| trxcMode2 | O | T | T | F | T |
| trxcMode3 | O | T | T | F | T |
| MaskActivationTime | O | T | T | F | T |
| sleepModeActivationTime | O | T | T | F | T |

The attribute constraints for TRXControl are shown in TABLE-8 A and TABLE-8B.

TABLE 8A

| Name | Definition |
|---|---|
| dataDir | Condition: When O-Ru supports TRx Control |
| CM support | sub use case of Network energy saving feature |
| qualifier | and O-Ru is configured to activate or deactivate |
| | that use case in uplink (Rx array) or downlink |
| | (Tx array), this parameter is mandatory |
| dataLayerConfig | Condition: When O-Ru supports TRx Control sub |
| CM support | use case of Network energy saving feature and |
| qualifier | O-RU is configured with associated data layer |
| | (spatial stream(s)) configuration wherever is |
| | applicable, this parameter is mandatory. |

TABLE 8B

| Name | Definition |
|---|---|
| trxCtrlPolicy | Condition: When O-Ru supports TRx Control sub |
| CM support | use case of Network energy saving feature and |
| qualifier | O-RU is configured to activate or deactivate |
| | TRx control sub use case, this parameter is |
| | mandatory. |

AdvancedSleepMode <<IOC>>—This IOC attribute may provide that may be required to configure O-DU to work with O-RU for enabling or disabling advanced sleep mode use case for achieving energy saving. The attribute may be inherited from NESManagementFunction IOC and may include the following attributes as shown in TABLE-9.

TABLE 9

| Attribute name | S | isReadable | isWritable | isInvariant | isNotifyable |
|---|---|---|---|---|---|
| asmSwitch | CM | T | T | F | T |
| asmState | CM | T | T | F | T |
| asmPolicy | CM | T | T | F | T |

The attribute constraints for AdvancedSleepMode <<IOC>> are shown in TABLE-Name Definition

TABLE 10

| Name | Definition |
|---|---|
| asmSwitch | Condition: When O-RU supports Network Energy |
| CM support | Savings feature and control (enable or disable) |
| qualifier | Advanced Sleep Mode use case in O-RU, this |
| | parameter is mandatory. |
| asmState | Condition: When is configured with Advanced |
| CM support | Sleep Mode use case and to notify the activation |
| qualifier | or deactivation state of the use case, this |
| | parameter is mandatory. |
| asmPolicy | Condition: when O-RU supports Advanced Sleep |
| CM support | Mode use case of a Network Energy Saving feature |
| qualifier | and O-RU is configured to activate or deactivate |
| | Advanced Sleep Mode use case, this parameter is |
| | mandatory |

ASMControl <<IOC>>—This IOC attribute may provide that may be required to configure O-DU to work with O-RU for activating or deactivating specific sleep mode use case for achieving energy saving. The attribute may be inherited from AdvancedSleepMode IOC and may include the following attributes as shown in TABLE-11

TABLE 11

| Attribute name | S | isReadable | isWritable | isInvariant | isNotifyable |
|---|---|---|---|---|---|
| dataDir | CM | T | T | F | T |
| sleepMode0 | O | T | T | F | T |
| sleepMode1 | O | T | T | F | T |
| sleepMode2 | O | T | T | F | T |
| sleepMode3 | O | T | T | F | T |
| sleepModeActivationTime | O | T | T | F | T |

The attribute constraints for ASMControl <<IOC>> are shown in TABLE-12

| Name | Definition |
|---|---|
| dataDir | Condition: When O-RU supports Advanced Sleep |
| CM support | Mode use-case of Network energy saving feature |
| qualifier | and O-RU is configured to activate or deactivate |
| | that use case in uplink or downlink, this parameter |
| | is mandatory. |

According to embodiments, an example of O-DU data model is as follows:

```
module: o-ran-o-du-nes.yang
augment /me3 gpp:ManagedElement/gnbdu3gpp:GNBDUFunction: NRCellDU or
NRSectorCarrier:
+−−rw NESManagementFunction* enumeration
  +−−rw id string
  +−−rw attributes
```

| +−−rw esNotAllowedTimePeriod? string | |
|---|---|
| +−−rw | trxCtrlSwitch* |
| +−−rw | trxCtrlState* |
| +−−rw | asmSwitch* |
| +−−rw | asmState* |

```
+−−rw CarrierSwitchOffOn*
  +−−rw id string
  +−−rw attributes
```

+−−rw csSwitch* string
+−−rw csState* string
+−−rw csPolicy* string

+−−rw CSControl* enumeration
+−−rw id string

| | |
|---|---|
| +−−rw | attributes |
| | +−−rw carrierDeactivationTime? string |

```
+−−rw RFChannelSwitchOffOn* enumeration
  +−−rw id string
  +−−rw attributes
```

+−−rw trxCtrlSwitch* string
+−−rw trxCtrlState* string
+−−rw trxCtrlPolicy* string

```
+−−rw TRXControl* enumeration
  +−−rw id string
  +−−rw attributes
```

| +−−rw dataDir uint8 | |
|---|---|
| +−−rw maskName ? string | |
| +−−rw | antennaMaskValues ? uint16/string |
| +−−rw | trxcMode0 ? string |
| +−−rw | trxcMode1 ? string |
| +−−rw | trxcMode2 ? string |
| +−−rw | trxcMode3 ? string |
| +−−rw | maskActivationTime ? string |
| +−−rw | sleepModeActivationTime ? string |
| | +−−rw dataLayerConfig string |

```
+−−rw AdvancedSleepMode* enumeration
  +−−rw id string
  +−−rw attributes
```

+−−rw asmSwitch* string
+−−rw asmState* string
+−−rw asmPolicy* string

```
+−−rw ASMControl* enumeration
  +−−rw id string
  +−−rw attributes
```

| +−−rw dataDir uint8 | |
|---|---|
| +−−rw | sleepMode0 ? string |
| +−−rw | sleepMode1 ? string |
| +−−rw | sleepMode2 ? string |
| +−−rw | sleepMode3 ? string |
| +−−rw | sleepModeActivationTime ? string |

In some embodiments, some of the O-RAN WG4 defined YANG models may be optional to support an optional capability. For instance, if a device does not return the namespace associated with an optional O-RAN WG4 defined YANG model, the NETCONF client may infer that a device does not support the optional capability associated with the O-RAN WG4 defined YANG model. An Optional O-RAN WG4 Namespace is shown in TABLE-13.

TABLE 13

| | Optional | | |
|---|---|---|---|
| No | Functionality | Reference | Namespace |
| 1 | Antenna Line Device | O-RAN WG4 Management | ″urn:o-ran:ald-port:x.y″ |
| | | Plane Specification [2], | ″urn:o-ran:ald: x.y ″ |
| | | Clause 14.4 | |
| 2 | External IO Port | O-RAN WG4 Management | ″urn:o-ran:external- |
| | | Plane Specification [2], | io:x.y ″ |
| | | Clause 14.5 | |
| 3 | eCPRI delay measurement | O-RAN WG4 Management | ″urn:o- |
| | | Plane Specification [2], | ran:message5:x.y ″ |
| | | Clause 7.7 | |
| 4 | UDP Echo functionality | O-RAN WG4 Management | ″urn:o-ran:udpecho:x.y |
| | for IP based transport | Plane Specification [2], | ″ |
| | verification | Clause 7.6 | |
| 5 | Beamforming | O-RAN WG4 Management | ″urn:o- |
| | | Plane Specification [2], | ran:beamforming:x.y ″ |
| | | Clause 15.4 | |
| 6 | FAN | — | “urn:o-ran:fan:x.y” |
| 7 | LAA | O-RAN WG4 Management | ″urn:o-ran:laa:x.y ″ |
| | | Plane Specification [2], | ″urn:o-ran:laa- |
| | | Clause 5 | operations:x.y ″ |
| 8 | Antenna calibration | O-RAN WG4 Management | ″urn:o-ran:antcal: x.y ″ |
| | | Plane Specification [2], | |
| | | Clause 15.5 | |
| 9 | Shared cell (common to | O-RAN WG4 Management | ″urn:o-ran:shared- |
| | FHM and Cascade modes) | Plane Specification [2], | cell:x.y″ |
| | | Clause 17 | ″urn:o-ran:ethernet- |
| | | | fwd:x.y″ |
| 10 | Configured subscription | O-RAN WG4 Management | ″urn:o-ran:ves-sn:1.0″ |
| | transported using VES | Plane Specification [2], | |
| | common header | Clause 18 | |

In some embodiments, some of the O-RAN WG5 defined YANG models may define optional feature support. The optional multi-vendor features defined in the O-RAN WG5 defined YANG models are shown below in TABLE-14

TABLE 14

| No | Optional Feature | Namespace | Feature Name |
|---|---|---|---|
| 1 | O-RU Energy saving | “urn:o-ran:o-du-nes:x.y“ | ENERGYSAVING |
| 2 | O-RU Energy saving by | | TRX-CONTROL |
| | TRx Control | | |
| 3 | O-RU Energy saving by | | ADVANCED- |
| | Advanced sleep mode | | SLEEP-MODE |

In some other embodiments, in addition to optional namespaces and optional features within supported namespaces, certain O-RAN WG5 may be defined YANG models that are used to expose support for certain optional capabilities by the O-DU. Optional capabilities in O-RAN WG5 defined YANG models is shown in TABLE-15.

TABLE 15

| No | Optional Feature | Namespace | Leaf |
|---|---|---|---|
| 1 | O-RU Energy saving | “urn:o-ran:o-du- | augumented/ |
| | by Carrier and Cell | nes:x.y“ | NesManagementFunction/ |
| | Switch Off/On | | CarrierandCellSwitchOffOn |
| 2 | O-RU Energy saving | | augumented/ |
| | by RF Channel | | NesManagementFunction/ |
| | Switch Off/On (TRx | | RfChannelSwitchOffOn/ |
| | Control) | | TrxControl |
| 3 | O-RU Energy saving | | augumented/ |
| | by Advanced Sleep | | NesManagementFunction/ |
| | Mode | | AdvancedSleepMode |
| 4 | Mask activation time | | augumented/ |
| | | | NesManagementFunction/ |
| | | | RfChannelSwitchOffOn/ |
| | | | TrxControl/ |
| | | | MaskActivationTime |
| 5 | Sleep Mode | | augumented/ |
| | activation time | | NesManagementFunction/ |
| | | | RfChannelSwitchOffOn/ |
| | | | TrxControl/ |
| | | | SleepModeActivationTime |
| | | | augumented/ |
| | | | NesManagementFunction/ |
| | | | AdvancedSleepMode/ |
| | | | SleepModeActivationTime |

In some embodiments, given below are various performance counters for O-CU. In some embodiments, a DLPDCP SDU Data Volume measurement per F1-U interface is shown in TABLE-16. This measurement may provide data volume (amount of PDCP SDU bits) in a downlink delivered from GNB-CU-UP to GNB-DU (F1-U interface) to an external gNB-CU-UP (Xn-U interface) and to an external eNB (X2-U interface). This measurement may be calculated per QoS level (mapped 5QI or QCI in NR option 3) and per Single-Network Slice Selection Assistance Information (S-NSSAI) and per S-NSSAI and per Public Land Mobile Network Identifier (PLMN ID), and reported per interface (F1-U, Xn-U, X2-U). This measurement may include Channel Configuration (CC).

Furthermore, in some embodiments, this measurement may be obtained by counting the number of DL PDCP SDU bits sent to GNB-DU (F1-U interface), sent to an external gNB-CU-UP (XnU interface) and which is sent to an external eNB (X2-U interface). This measurement is performed in GNB-CU-UP per QoS level (mapped 5QI or QCI in NR option 3) and per S-NSSAI and per S-NSSAI and per PLMN ID, and reported per interface (F1-U, Xn-U, X2-U).

Furthermore, in some embodiments, each measurement may be an integer value representing the number of bits measured in Mbits, where, (1 MBits=1000*1000 bits). The number of measurements is equal to the number of QoS levels per interface plus the number of S-NSSAIs per interface plus the number of PLMN ID.

Furthermore, in some embodiments, the measurement name may be in the form DRB.FluPdcpSduVolumnDL_Filter. The filter may be a combination of PLMN ID and QoS level and S-NSSAI, i.e., FI-U interface measurements and Xn-U interface measurements. In some other embodiments, the filter may be a combination of PLMN ID and QoS level, i.e., X2-U interface measurements. The PLMN-ID may represent a PLMN-ID, QoS represent may a mapped 5QI or a QCI level and SNSSAI may represent S-NSSAI.

In some embodiments, an EP_F1U (F1U interface), EP_XnU (Xn-U interface) and EP_X2U (X2-U interface) may be included.

In some embodiments, this measurement may be valid for packet switched traffic. In some embodiments, this may be applicable for 5GS.

In some embodiments, some usage may be for performance assurance with integrity area (user plane connection quality) in an Energy Efficiency (EE) area.

TABLE 16

| | Measurement Name |
|---|---|
| | OR.PDCPB.DlPdcpSduDataVolF1u |
| Description | Refer to 3GPP TS 28.552 [8] clause 5.1.3.6.2.3 |
| | O-RAN addition: |
| | The measurement is for F1-U interface. |
| | The measurement is optionally split into sub counters per QoS |
| | level (mapped 5QI or QCI in NR option 3) or per S-NSSAI. An |
| | instance of Cucountgroup IOC may be used to define subcounter |
| | configurations. |
| Collection | Refer to 3GPP TS 28.552 [8] clause 5.1.3.6.2.3 |
| Method | |
| Condition | Refer to 3GPP TS 28.552 [8] clause 5.1.3.6.2.3 |
| | The measurement is for F1-U interface. |
| | The subcounter per QoS level should be regarded as subcounter |
| | QoS, SNSSAI or Cucountgroup. |
| | Note: excludes DL PDCP SDU transmitted as data forwarding. |
| Measurement | Refer to 3GPP TS 28.552 [8] clause 5.1.3.6.2.3 |
| Result | |
| Measurement | Refer to 3GPP TS 28.552 [8] clause 5.1.3.6.2.3 |
| Type | O-RAN addition: |
| | OR.PDCPB.DlPdcpSduDataVolF1u, or optionally |
| | OR.PDCPB.DlPdcpSduDataVolF1u.QoS, where QoS identifies |
| | the target quality of service class, and |
| | OR.PDCPB.DlPdcpSduDataVolF1u.SNSSAI, where SNSSAI |
| | identifies the S-NSSAI, and |
| | OR.PDCPB.DlPdcpSduDataVolF1u.Cucountgroup, where |
| | Cucountgroup identifies an instance of CuCountGroup IOC. |
| Measurement | Refer to 3GPP TS 28.552 [8] clause 5.1.3.6.2.3 |
| Object Class | |
| Switching | Refer to 3GPP TS 28.552 [8] clause 5.1.3.6.2.3 |
| Technology | |
| Generation | Refer to 3GPP TS 28.552 [8] clause 5.1.3.6.2.3 |
| Purpose | Refer to 3GPP TS 28.552 [8] clause 5.1.3.6.2.3 |

An Artificial Intelligence/Machine Learning (AI/ML) model is shown in TABLE-17

TABLE 17
Input Data

| | | | | Reporting | Existing/New |
|---|---|---|---|---|---|
| Interface | Source/Target | Name/Description | Units | Period | Definitions |
| O1, R1 | E2 Node | DL PDCP SDU | Mbit | (non-real | Measurement: |
| | (O-CU)/SMO/rApp | Volume per | | time for | 3GPP TS |
| | | interface (Data | | training) | 28.552 [12] |
| | | Volume in DL | | | (C15.1.3.6.2.3) |
| | | delivered from | | | |
| | | O-CU-UP to O-DU | | | |
| | | per PLMN, per | | | |
| | | QoS level, per | | | |
| | | slice, per interface | | | |
| | | (F1-U, Xn-U, | | | |
| | | X2-U)) | | | |

In some embodiments, a UL PDCP SDU Data Volume per F1-U interface is shown in TABLE-18. This measurement may provide data volume (amount of PDCP) in a uplink delivered to GNB-CU-UP from GNB-DU (F1-U interface) from an external gNB-CU-UP (Xn-U interface) and from an external eNB (X2-U interface). This measurement may be calculated per QoS level (mapped 5QI or QCI in NR option 3) and per S-NSSAI and per S-NSSAI and per PLMN ID, and reported per interface (F1-U, Xn-U, X2-U). This measurement may include CC. In some embodiments, UL is abbreviated as Up link and DU is abbreviated as down link.

Furthermore, in some embodiments, this measurement may be obtained by counting the number of UL PDCP SDU bits entering the GNB-CU-UP from GNB-DU (F1-U interface), from an external gNB-CU-UP (Xn-U interface) and from external eNB (X2-U interface). This measurement is performed in GNB-CU-UP per QoS level (mapped 5QI or QCI in NR option 3) and per S-NSSAI and per PLMN ID, and reported per interface (F1-U, Xn-U, X2-U).

Furthermore, in some embodiments, each measurement may be an integer value representing the number of bits measured in Mbits, where, (1 MBits=1000*1000 bits). The number of measurements is equal to the number of QoS levels per interface plus the number of S-NSSAIs per interface plus the number of PLMN ID.

Furthermore, in some embodiments, the measurement name may be in the form DRB.FluPdcpSduVolumnUL_Filter. The filter may be a combination of PLMN ID and QoS level and S-NSSAI, i.e., FI-U interface measurements and Xn-U interface measurements. In some other embodiments, the filter may be a combination of PLMN ID and QoS level, i.e., X2-U interface measurements. The PLMN-ID may represent a PLMN-ID, QoS represent a mapped 5QI or a QCI level and SNSSAI may represent S-NSSAI.

In some embodiments, an EP_F1U (F1U interface), EP_XnU (Xn-U interface) and EP_X2U (X2-U interface) may be included.

In some embodiments, this measurement may be valid for packet switched traffic. In some embodiments, this may be applicable for 5GS.

In some embodiments, some usage may be for performance assurance with integrity area (user plane connection quality) in an Energy Efficiency (EE) area.

TABLE 18

| | Measurement Name |
|---|---|
| | OR.PDCPB.UlPdcpSduDataVolF1u |
| Description | Refer to 3GPP TS 28.552 [8] clause 5.1.3.6.2.4 |
| | O-RAN addition: |
| | The measurement is for F1-U interface. |
| | The measurement is optionally split into sub counters per QoS |
| | level (mapped 5QI or QCI in NR option 3) or per S-NSSAI. An |
| | instance of Cucountgroup IOC may be used to define subcounter |
| | configurations. |
| Collection | Refer to 3GPP TS 28.552 [8] clause 5.1.3.6.2.4 |
| Method | |
| Condition | Refer to 3GPP TS 28.552 [8] clause 5.1.3.6.2.4 |
| | The measurement is for F1-U interface. |
| | The subcounter per QoS level should be regarded as subcounter |
| | QoS, SNSSAI or Cucountgroup. |
| | Note: excludes UL PDCP SDU transmitted as data forwarding. |
| Measurement | Refer to 3GPP TS 28.552 [8] clause 5.1.3.6.2.4 |
| Result | |
| Measurement | Refer to 3GPP TS 28.552 [8] clause 5.1.3.6.2.4 |
| Type | O-RAN addition: |
| | OR.PDCPB.UlPdcpSduDataVolF1u, or optionally |
| | OR.PDCPB.UlPdcpSduDataVolF1u.QoS, where QoS identifies |
| | the target quality of service class, and |
| | OR.PDCPB.UlPdcpSduDataVolF1u.SNSSAI, where SNSSAI |
| | identifies the S-NSSAI, and |
| | OR.PDCPB.UlPdcpSduDataVolF1u.Cucountgroup, where |
| | Cucountgroup identifies an instance of CuCountGroup IOC. |
| Measurement | Refer to 3GPP TS 28.552 [8] clause 5.1.3.6.2.4 |
| Object Class | |
| Switching | Refer to 3GPP TS 28.552 [8] clause 5.1.3.6.2.4 |
| Technology | |
| Generation | Refer to 3GPP TS 28.552 [8] clause 5.1.3.6.2.4 |
| Purpose | Refer to 3GPP TS 28.552 [8] clause 5.1.3.6.2.4 |

An Artificial Intelligence/Machine Learning (AI/ML) model for UL PDCP SDU is shown in TABLE-19

TABLE 19
Input Data

| | | | | Reporting | Existing/New |
|---|---|---|---|---|---|
| Interface | Source/Target | Name/Description | Units | Period | Definitions |
| O1, R1 | E2 Node | UL PDCP SDU | Mbit | (non-real | Measurement: |
| | (O-CU)/SMO/rApp | Volume per | | time for | 3GPP TS |
| | | interface (Data | | training) | 28.552 [12] |
| | | Volume in UL | | | (C15.1.3.6.2.4) |
| | | delivered to | | | |
| | | O-CU-UP from | | | |
| | | O-DU per | | | |
| | | PLMN, per QoS | | | |
| | | level, per slice, | | | |
| | | per interface | | | |
| | | (F1-U, Xn-U, | | | |
| | | X2-U)) | | | |

Given below are various exemplary embodiments illustrating various performance counters for O-DU. In some embodiments, a Reference Signal Received Quality (RSRQ) measurement is shown in TABLE-20. This measurement may provide a distribution of SS-RSRQ that may be received by a gNB from UEs in a cell. A periodical UE measurement may report towards all of the UEs that may required to be triggered by gNB in a measured New Radio cell (also refer TS 28.331[20]). This measurement may include CC.

In some embodiments, this measurement may be obtained by incrementing an appropriate measurement bin using a measured quantity value (also refer table 10.1.11.1-1 in TS 28.133 [35], clause 5.1.3 SS Reference Signal Received Quality (SS-RSRQ) in 38.215[34]) when RSRQ value is reported by a UE and when a RSRQ is used for MeasQuantityResults IE that is in resultsSSB-Cell IE within the measResult IE as configured by a MeasurementReport configurations as defined in TS 38.331 [20]).

In some embodiments, this measurement may be a set of integers. This measurement may include a MR.NRScSSRSRQ.BinX, where X may represent a range of measured quality SS-RSRQ value (−43 to 20 dB). In some cases, number of bins and range may be left for implementation. This measurement may include a NRCellCU. In some embodiments, this measurement may be valid for packet switch traffic. In some embodiments, this measurement may be applicable in 5GS.

TABLE 20

| | Measurement Name |
|---|---|
| | OR.RSRQMR. NRScSSRSRQ.BinX |
| Description | Refer to 3GPP TS 28.552 [14] clause 5.1.1.31 |
| | O-RAN addition: |
| | The RSRQ measurement is optional counter |
| | The counter measurement optionally performed to estimate the |
| | distribution of SS-RSRQ received by gNB from UEs in the cell. |
| | The periodical UE measurement reports towards all of the UEs |
| | need to be triggered by gNB in the measured New Radio cell. |
| Collection | Refer to 3GPP TS 28.552 [14] clause 5.1.1.31 |
| Method | |
| Condition | Refer to 3GPP TS 28.552 [14] clause 5.1.1.31 |
| | This measurement is obtained by incrementing the appropriate |
| | measurement bin using measured quantity value when a RSRQ |
| | value is reported by a UE when RSRQ is used for |
| | MeasQuantityResults IE that is in resultsSSB-Cell IE within the |
| | measResult IE as configured by MeasurementReport |
| | configurations. |
| Measurement | Refer to 3GPP TS 28.552 [14] clause 5.1.1.31 |
| Result | |
| Measurement | Refer to 3GPP TS 28.552 [14] clause 5.1.1.31 |
| Type | O-RAN addition: |
| | OR.RSRQMR. NRScSSRSRQ.BinX, where X represents the |
| | range of Measured quantity SS-RSRQ value (−43 to 20 dB) |
| Measurement | Refer to 3GPP TS 28.552 [14] clause 5.1.1.31 |
| Object Class | |
| Switching | Refer to 3GPP TS 28.552 [14] clause 5.1.1.31 |
| Technology | |
| Generation | Refer to 3GPP TS 28.552 [14] clause 5.1.1.31 |
| Purpose | Refer to 3GPP TS 28.552 [14] clause 5.1.1.31 |

An AI/ML model for RSRQ measurement is shown in TABLE-21.

TABLE 21
Input Data

| | | | | Reporting | Existing/New |
|---|---|---|---|---|---|
| Interface | Source/Target | Name/Description | Units | Period | Definitions |
| E2 | E2 Node | RSRQ | dB | ~per Nx | Measurement: |
| | (O-DU)/Near-RT | measurement as | | 100 ms | 3GPP TS 28.552 |
| | RIC | per SSB per cell | | | [12] (C1.5.1.1.31) |
| | | | | | Reporting: |
| | | | | | O-RAN.WG3.E2SM-KPM |

In some embodiments, a RSRP measurement is shown in TABLE-21. This measurement may provide a distribution of SS-RSRP per SSB (See TS 28.215 [34]) that may be received by a gNB from UEs in a cell when RSRP is used for L1-RSRP as configured by reporting configurations as defined in TS 38.214 [33], in case the L1-RSRP report function may be enabled. This measurement may include CC.

In some embodiments, this measurement may be obtained by incrementing an appropriate measurement bin using a measured quantity value (also refer table 10.1.6.1-1 in TS 38.133 [35]) when a RSRP value is reported by a UE and when SS-RSRP is used for L1-RSRP configurations as defined in TS 38.214 [33].

In some embodiments, each subcounter of the RSRP measurement may be an integer. This measurement may include a L1M.SS-RSRP.Bin, where Bin may represent range of reported SS-RSRP value (0-127 dBm). In some cases, number of bins and range may be left for implementation. This measurement may include a Beam. In some embodiments, this measurement may be valid for packet switch traffic. In some embodiments, this measurement may be applicable in 5GS. In some embodiments, one of the usages of this performance measurements is to support an Message Delivery Agent (MDA).

TABLE 22

| | Measurement Name |
|---|---|
| | OR.RSRPL1M.SS-RSRP.Bin |
| Description | Refer to 3GPP TS 28.552 [14] clause 5.1.1.22.1 |
| | O-RAN addition: |
| | The SS-RSRP distribution per SSB is optional subcounter. |
| | The subcounter measurement optionally provides the distribution of |
| | SS-RSRP per SSB received by gNB from UEs in the cell when SS-RSRP is |
| | used for L1-RSRP as configured by reporting configurations in case the |
| | L1-RSRP report function is enabled. |
| Collection | Refer to 3GPP TS 28.552 [14] clause 5.1.1.22.1 |
| Method | |
| Condition | Refer to 3GPP TS 28.552 [14] clause 5.1.1.22.1 |
| | This measurement is obtained by incrementing the appropriate |
| | measurement bin using measured quantity value when a RSRP value is |
| | reported by a UE when SS-RSRP is used for L1-RSRP as configured by |
| | reporting configurations. |
| Measurement | Refer to 3GPP TS 28.552 [14] clause 5.1.1.22.1 |
| Result | |
| Measurement | Refer to 3GPP TS 28.552 [14] clause 5.1.1.22.1 |
| Type | O-RAN addition: |
| | OR.RSRPL1M.SS-RSRP.Bin, where Bin represents the range of |
| | reported SS-RSRP value (0 to 127 dBm). |
| | Note: Number of bins and the range for each bin is left to |
| | implementation. |
| Measurement | Refer to 3GPP TS 28.552 [14] clause 5.1.1.22.1 |
| Object Class | |
| Switching | Refer to 3GPP TS 28.552 [14] clause 5.1.1.22.1 |
| Technology | |
| Generation | Refer to 3GPP TS 28.552 [14] clause 5.1.1.22.1 |
| Purpose | Refer to 3GPP TS 28.552 [14] clause 5.1.1.22.1 |

An AI/ML model for RSRQ measurement is shown in TABLE-23.

TABLE 23
Input Data

| | | | | Reporting | Existing/New |
|---|---|---|---|---|---|
| Interface | Source/Target | Name/Description | Units | Period | Definitions |
| E2 | E2 Node | RSRQ | dBm | ~per Nx | Measurement: |
| | (O-DU)/Near-RT | measurement as | | 100 ms | 3GPP TS 28.552 |
| | RIC | per SSB per UE | | | [12] (C1.5.1.1.22) |
| | | | | | Reporting: |
| | | | | | O-RAN.WG3.E2SM-KPM |

In some embodiments, a SS-RSRP distribution per SSB is shown in TABLE-24. This measurement may provide distribution of SS-RSRP as per SSB (See TS 38.215 [34]) of a neighbour New Radio (NR) cell received from gNB from UEs when SS-RSRP is used for L1-RSRP as configured by reporting configurations as defined in TS 38.214 [33], in case the L1-RSRP report function is enabled. This measurement may include CC.

In some embodiments, this measurement may be obtained by incrementing an appropriate bin using measured quantity value (See Table 10.1.6.1-1 in TS 38.133 [35]). A RSRP value for the SSB beam of the neighbour NR cell may be reported by a UE to the gNB via a Radio Resource Control (RRC) Measurement Report message (see TS 38.331 [20]).

In some embodiments, each subcounter of this SS-RSRP distribution may be an integer. In some embodiments, this measurement may include a L1M.SS-RSRPNrNbr.SSBIndex.Bin, where SSBIndex identifies the SSB beam of the neighbour NR cell and the Bin represents a range of reported SS-RSRP value (0-127). The number of bins and the range for each bin may be left for implementation. In some embodiments, this measurement may include a NRCellRelation. In some embodiments, this measurement may be valid for packet switched traffic. In some embodiments, this may be applicable for 5GS. In some embodiments, one of the usage of this performance measurement is to support MDA.

TABLE 24

| | Measurement Name |
|---|---|
| | OR.RSRPL1M.SS-RSRPNrNbr.SSBIndex.Bin |
| Description | Refer to 3GPP TS 28.552 [14] clause 5.1.1.22.2 |
| | O-RAN addition: |
| | The SS-RSRP distribution per SSB of neighbor NR cell is optional |
| | subcounter. |
| | The subcounter measurement optionally provides the distribution of |
| | SS-RSRP per SSB of a neighbour NR cell received by gNB from UEs when |
| | SS-RSRP is used for L1-RSRP as configured by reporting configurations |
| | in case the L1-RSRP report function is enabled. |
| Collection | Refer to 3GPP TS 28.552 [14] clause 5.1.1.22.2 |
| Method | |
| Condition | This measurement is obtained by incrementing the appropriate |
| | measurement bin using measured quantity value when a RSRP value for |
| | the SSB beam of the neighbor NR cell is reported by a UE to the gNB |
| | via RRC MeasurementReport message |
| Measurement | Refer to 3GPP TS 28.552 [14] clause 5.1.1.22.2 |
| Result | |
| Measurement | Refer to 3GPP TS 28.552 [14] clause 5.1.1.22.2 |
| Type | O-RAN addition: |
| | OR.RSRPL1M.SS-RSRPNrNbr.SSBIndex.Bin, where SSBIndex |
| | identifies the SSB beam of the neighbor NR cell; and the Bin represents |
| | the range of reported SS-RSRP value (0 to 127). |
| | Note: Number of bins and the range for each bin is left to implementation. |
| Measurement | Refer to 3GPP TS 28.552 [14] clause 5.1.1.22.2 |
| Object Class | |
| Switching | Refer to 3GPP TS 28.552 [14] clause 5.1.1.22.2 |
| Technology | |
| Generation | Refer to 3GPP TS 28.552 [14] clause 5.1.1.22.2 |
| Purpose | Refer to 3GPP TS 28.552 [14] clause 5.1.1.22.2 |

An AI/ML model for SS-RSRP distribution is shown in TABLE-25.

TABLE 25
Input Data

| | | | | Reporting | Existing/New |
|---|---|---|---|---|---|
| Interface | Source/Target | Name/Description | Units | Period | Definitions |
| E2 | E2 Node | RSRP | dBm | ~per Nx | Measurement: |
| | (O-DU)/Near-RT | measurement as | | 100 ms | 3GPP TS 28.552 |
| | RIC | per SSB per UE | | | [12] (C1.5.1.1.22) |
| | | | | | Reporting: |
| | | | | | O-RAN.WG3.E2SM-KPM |

In some embodiments, a RSRP distribution per neighbour E-UTRAN cell is shown in TABLE-26. This measurement may provide distribution of RSRP neighbour E-ULTRA cell that may received by gNB from UEs (See 38.331[20]). This measurement may include CC. This measurement may be obtained by incrementing an appropriate measurement bin using a measured quantity value (see Table 10.1.6.1-1 in TS 28.133 [35]) when a RSRP value for the neighbour E-ULTRA cell is reported by a UE to the gNB via RRC Measurement Report message (See TS 38.331[20])

In some embodiments, each subcounter of the RSRP distribution may be an integer. In some embodiments, this measurement may include L1M.RSRPEultraNbr.Bin, where Bin represents range of reported RSRP value to 97. The number of bins and the range for each bins is left to implementation. In some embodiments, this measurement may include EUtranCellRelation. In some embodiments, this measurement may be valid for a packet switched traffic. In some embodiments, this may be applicable for 5GS. In some embodiments, one of the usage of this performance measurement is to support MDA.

TABLE 26

| | Measurement Name |
|---|---|
| | OR.RSRPL1M.RSRPEutraNbr.Bin |
| Description | Refer to 3GPP TS 28.552 [14] clause 5.1.1.22.3 |
| | O-RAN addition: |
| | The RSRP distribution per neighbor E-UTRAN cell is optional subcounter. |
| | The subcounter measurement optionally provides the distribution of RSRP |
| | per neighbour E-UTRA cell received by gNB from UEs. |
| Collection | Refer to 3GPP TS 28.552 [14] clause 5.1.1.22.3 |
| Method | |
| Condition | This measurement is obtained by incrementing the appropriate |
| | measurement bin using measured quantity value when a RSRP value for |
| | the neighbour E-UTRA cell is reported by a UE to the gNB via RRC |
| | MeasurementReport message. |
| Measurement | Refer to 3GPP TS 28.552 [14] clause 5.1.1.22.3 |
| Result | |
| Measurement | Refer to 3GPP TS 28.552 [14] clause 5.1.1.22.3 |
| Type | O-RAN addition: |
| | OR.RSRPL1M.RSRPEutraNbr.Bin, where the Bin represents the range of |
| | reported RSRP value to 97). |
| | Note: Number of bins and the range for each bin is left to implementation. |
| Measurement | Refer to 3GPP TS 28.552 [14] clause 5.1.1.22.3 |
| Object Class | |
| Switching | Refer to 3GPP TS 28.552 [14] clause 5.1.1.22.3 |
| Technology | |
| Generation | Refer to 3GPP TS 28.552 [14] clause 5.1.1.22.3 |
| Purpose | Refer to 3GPP TS 28.552 [14] clause 5.1.1.22.3 |

An AI/ML model for RSRP distribution is shown in TABLE-27.

TABLE 27
Input Data

| | | | | Reporting | Existing/New |
|---|---|---|---|---|---|
| Interface | Source/Target | Name/Description | Units | Period | Definitions |
| E2 | E2 Node | RSRP | dBm | ~per Nx | Measurement: |
| | (O-DU)/Near-RT | measurement | | 100 ms | 3GPP TS 28.552 |
| | RIC | based on SSB per | | | [12] (C1.5.1.1.22) |
| | | UE | | | Reporting: |
| | | | | | O-RAN.WG3.E2SM-KPM |

In some embodiments, a SNIR measurement is shown in TABLE-28. This measurement may provide distribution of SS-SNIR that may received by gNB from UEs in the cell. The periodical UE measurement reports towards all of the UEs that may required to be triggered by gNB in a measured New Radio cell (See 38.331[20]). This measurement may include CC. This measurement may be obtained by incrementing an appropriate measurement bin using a measured quantity value (see Table 10.1.6.1-1 in TS 38.133 [35]) when a SNIR value is reported by a UE when snir is used for MeasQuantityResults IE that is in resultsSSB-Cell IE within the measResult IE as configured by MeasurementReport configurations as defined in TS 38.331[20].

In some embodiments, each subcounter of the SINR measurement may be an integer. In some embodiments, this measurement may include MR.NRScSSSINR.BinX, where X represents range of measured quantity SS-SNIR value (−23 to 40 dB). The number of bins and the range for each bins is left to implementation. In some embodiments, this measurement may include NRCellCU. In some embodiments, this measurement may be valid for a packet switched traffic. In some embodiments, this may be applicable for 5GS.

TABLE 28

| | Measurement Name |
|---|---|
| | OR.SINRMR.NRScSSSINR.BinX |
| Description | Refer to 3GPP TS 28.552 [14] clause 5.1.1.22.3 |
| | O-RAN addition: |
| | The SINR measurement is optional subcounter. |
| | The subcounter measurement optionally provides the distribution of |
| | SS-SINR received by gNB from UEs in the cell. The periodical UE |
| | measurement reports towards all of the UEs need to be triggered by gNB in |
| | the measured New Radio cell. |
| Collection | Refer to 3GPP TS 28.552 [14] clause 5.1.1.22.3 |
| Method | |
| Condition | This measurement is obtained by incrementing the appropriate |
| | measurement bin using measured quantity value when a SINR value is |
| | reported by a UE when SINR is used for MeasQuantityResults IE that is in |
| | resultsSSB-Cell IE within the measResult IE as configured by |
| | MeasurementReport configurations. |
| Measurement | Refer to 3GPP TS 28.552 [14] clause 5.1.1.22.3 |
| Result | |
| Measurement | Refer to 3GPP TS 28.552 [14] clause 5.1.1.22.3 |
| Type | O-RAN addition: |
| | OR.SINRMR.NRScSSSINR.BinX, where X represents the range of |
| | Measured quantity SS-SINR value (−23 to 40 dB). |
| | Note: Number of bins and the range for each bin is left to implementation. |
| Measurement | Refer to 3GPP TS 28.552 [14] clause 5.1.1.22.3 |
| Object Class | |
| Switching | Refer to 3GPP TS 28.552 [14] clause 5.1.1.22.3 |
| Technology | |
| Generation | Refer to 3GPP TS 28.552 [14] clause 5.1.1.22.3 |
| Purpose | Refer to 3GPP TS 28.552 [14] clause 5.1.1.22.3 |

An AI/ML model for SNIR measurement is shown in TABLE-29

TABLE 29
Input Data

| | | | | Reporting | Existing/New |
|---|---|---|---|---|---|
| Interface | Source/Target | Name/Description | Units | Period | Definitions |
| E2 | E2 Node | SNIR | dB | ~per Nx | Measurement: |
| | (O-DU)/Near-RT | measurement | | 100 ms | 3GPP TS 28.552 |
| | RIC | based on SSB per | | | [12] (C1.5.1.1.32) |
| | | UE | | | Reporting: |
| | | | | | O-RAN.WG3.E2SM-KPM |

Based on the above embodiments, SMO-based NES approaches using the O1 interface may allow for more optimized energy consumption across the network since decisions may be made using real-time data and/or predictive analysis to adjust power profiles, improved automation, as well as more optimized resource allocation

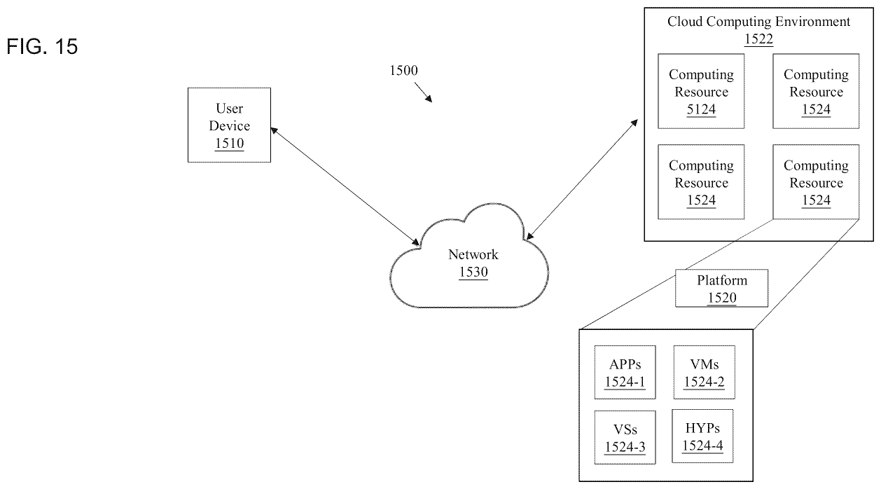

FIG. 15 is a diagram of an example environment 1500 in which systems and/or methods, described herein, may be implemented. As shown in FIG. 15, environment 1500 may include a user device 1510, a platform 1520, and a network 1530. Devices of environment 1500 may interconnect via wired connections, wireless connections, or a combination of wired and wireless connections. In embodiments, any of the functions and operations described with reference to FIGS. 2-14 above may be performed by any combination of elements illustrated in FIG. 15.

User device 1510 includes one or more devices capable of receiving, generating, storing, processing, and/or providing information associated with platform 1520. For example, user device 1510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1510 may receive information from and/or transmit information to platform 1520.

Platform 1520 includes one or more devices capable of receiving, generating, storing, processing, and/or providing information. In some implementations, platform 1520 may include a cloud server or a group of cloud servers. In some implementations, platform 1520 may be designed to be modular such that certain software components may be swapped in or out depending on a particular need. As such, platform 1520 may be easily and/or quickly reconfigured for different uses.

In some implementations, as shown, platform 1520 may be hosted in cloud computing environment 1522. Notably, while implementations described herein describe platform 1520 as being hosted in cloud computing environment 1522, in some implementations, platform 1520 may not be cloud-based (i.e., may be implemented outside of a cloud computing environment) or may be partially cloud-based.

Cloud computing environment 1522 includes an environment that hosts platform 1520. Cloud computing environment 1522 may provide computation, software, data access, storage, etc., services that do not require end-user (e.g., user device 1510) knowledge of a physical location and configuration of system(s) and/or device(s) that hosts platform 1520. As shown, cloud computing environment 1522 may include a group of computing resources 1524 (referred to collectively as “computing resources 1524” and individually as “computing resource 1524”).

Computing resource 1524 includes one or more personal computers, a cluster of computing devices, workstation computers, server devices, or other types of computation and/or communication devices. In some implementations, computing resource 1524 may host platform 1520. The cloud resources may include compute instances executing in computing resource 1524, storage devices provided in computing resource 1524, data transfer devices provided by computing resource 1524, etc. In some implementations, computing resource 1524 may communicate with other computing resources 1524 via wired connections, wireless connections, or a combination of wired and wireless connections.

As further shown in FIG. 15, computing resource 1524 includes a group of cloud resources, such as one or more applications (“APPs”) 1524-1, one or more virtual machines (“VMs”) 1524-2, virtualized storage (“VSs”) 1524-3, one or more hypervisors (“HYPs”) 1524-4, or the like.

Application 1524-1 includes one or more software applications that may be provided to or accessed by user device 1510. Application 1524-1 may eliminate the need to install and execute the software applications on user device 1510. For example, application 1524-1 may include software associated with platform 1520 and/or any other software capable of being provided via cloud computing environment 1522. In some implementations, one application 1524-1 may send/receive information to/from one or more other applications 1524-1, via virtual machine 1524-2.

Virtual machine 1524-2 includes a software implementation of a machine (e.g., a computer) that executes programs like a physical machine. Virtual machine 1524-2 may be either a system virtual machine or a process virtual machine, depending upon use and degree of correspondence to any real machine by virtual machine 1524-2. A system virtual machine may provide a complete system platform that supports execution of a complete operating system (“OS”). A process virtual machine may execute a single program, and may support a single process. In some implementations, virtual machine 1524-2 may execute on behalf of a user (e.g., user device 1510), and may manage infrastructure of cloud computing environment 1522, such as data management, synchronization, or long-duration data transfers.

Virtualized storage 1524-3 includes one or more storage systems and/or one or more devices that use virtualization techniques within the storage systems or devices of computing resource 1524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1524-4 may provide hardware virtualization techniques that allow multiple operating systems (e.g., “guest operating systems”) to execute concurrently on a host computer, such as computing resource 1524. Hypervisor 1524-4 may present a virtual operating platform to the guest operating systems and may manage the execution of the guest operating systems. Multiple instances of a variety of operating systems may share virtualized hardware resources.

Network 1530 includes one or more wired and/or wireless networks. For example, network 1530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 15 are provided as an example. In practice, there may be additional devices and/or networks, fewer devices and/or networks, different devices and/or networks, or differently arranged devices and/or networks than those shown in FIG. 15. Furthermore, two or more devices shown in FIG. 15 may be implemented within a single device, or a single device shown in FIG. 15 may be implemented as multiple, distributed devices. Additionally, or alternatively, a set of devices (e.g., one or more devices) of environment 1500 may perform one or more functions described as being performed by another set of devices of environment 1500.

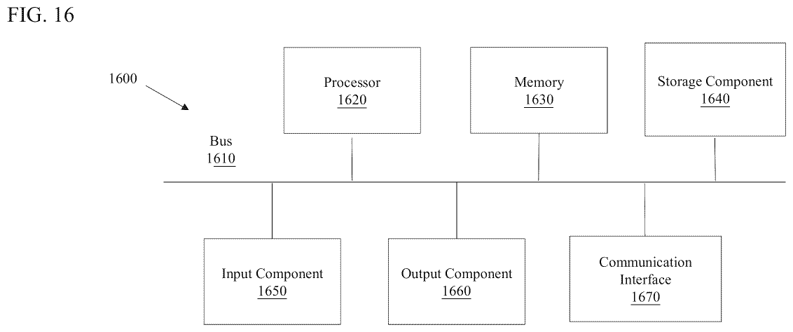

FIG. 16 illustrates an embodiment of a device 1600. As shown in FIG. 16, the device 1600 processor 1610, a memory 1620, a storage component 1630, an input component 1640, an output component 1650, a communication interface 1660, and a bus 1670.

The processor 1610, as used herein, means any type of computational circuit that may comprise hardware elements and software elements. The processor 1610 may be embodied as a multi-core processor, a single core processor, or a combination of one or more multi-core processors and/or one or more single core processors, a distributed processing system, or the like. The processor 1610 may be a Central Processing Unit (CPU) a graphics processing unit (GPU), an accelerated processing unit (APU), an application-specific integrated circuit (ASIC), or another type of processing component.

Memory 1620 includes a non-transitory computer readable medium. Memory 1620 includes a random-access memory (RAM), a read only memory (ROM), and/or another type of dynamic or static storage device (e.g., a flash memory, a magnetic memory, and/or an optical memory) that stores information and/or instructions for use by processor 1610. The memory 1620 comprises machine-readable instructions which are executable by the processor 1610. These machine-readable instructions when executed by the processor 1610 cause the processor 1610 to perform one or more method steps of an embodiment described above.

Storage component 1630 stores information and/or software related to the operation and use of the device 1600. For example, storage component 1630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1640 is configured to receive information, such as user input. For example, the input component 1640 may include, but not be limited to, a touch screen display, a keyboard, a keypad, a mouse, a button, a switch, and/or a microphone. Additionally, or alternatively, the input component 1640 may include a sensor for sensing information (e.g., a global positioning system (GPS), an accelerometer, a gyroscope, and/or an actuator).

Output component 1650 is configured to provide output information from the device 1600. For example, the output component 1650 may be, but not limited to, a display, a speaker, instructions to an external device, and/or one or more light-emitting diodes (LEDs).

Communication interface 1660 is an interface that provides a communication connection to other devices, such as external devices and internal devices. The connection by the communication interface 1660 can be a wired connection, a wireless connection, or a combination of wired and wireless connections, and can be a direct connection or an indirect connection via a communication network that exists between the device 1600 and other devices. In other words, the standard of the communication interface 1660 is not limited.

The bus 1670 acts as an interconnect between the processor 1610, the memory 1620, the storage component 1630, the input component 1640, the output component 1650, and the communication interface 1660 of the device 1600. The bus 1670 may include a wired interconnection or a wireless interconnection.

The number and arrangement of components shown in FIG. 16 are provided as an example. In practice, device 1600 may include additional components, fewer components, different components, or differently arranged components than those shown in FIG. 16. Additionally, or alternatively, a set of components (e.g., one or more components) of device 1600 may perform one or more functions described as being performed by another set of components of device 1600. Further, one or more method steps described in any of the embodiments may be performed utilizing a plurality of devices 1600 in communication with one another.

In embodiments, any one of the operations or processes of FIGS. 2-14 may be implemented by or using any one of the elements illustrated in FIGS. 15 and 16. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]: A method, including: sending, by an Open Radio Access Network (O-RAN) Distributed Unit (O-DU), network energy saving (NES) information including at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface one of a management plane (M-Plane) or a control plane (C-Plane) based at least in part on the received message; and sending, by the O-DU to the SMO, a notification indicating whether activation of the TRx control configuration was successful.
Item [2]: The method according to Item [1], further including: receiving, by the O-DU from the O-RU, supported TRx Control antenna masks and antenna array configurations, wherein the NES information further includes the supported TRx Control antenna masks and antenna array configurations, and wherein the O-DU and SMO are only allowed to set the TRx Control Configuration that include the supported TRx Control antenna masks and antenna array configurations.
Item [3]: The method according to Item [1], wherein the NES information does not include an antenna mask or antenna array configuration, and the O-DU and SMO are enabled to set the TRx Control Configuration to use any of plural antenna mask and antenna array configurations.
Item [4]: The method according to any one of Items [1]-[3], wherein the message includes a U-plane Yet Another Generation (YANG) configuration indicating a specific TRx Control configuration.
Item [5]: The method according to Item [4], wherein the setting the TRx Control configuration includes: applying, by the O-DU to the O-RU, the specific TRx Control configuration receiving, by the O-DU from the O-RU, a notification with parameters based on applying the specific TRx Control configuration.
Item [6]: The method according to any one of Items [1]-[3], wherein the message includes a policy indicating a specific TRx Control configuration.
Item [7]: The method according to Item [6], wherein the setting the TRx Control configuration includes: processing, by the O-DU, the policy to obtain parameters of the TRx Control configuration. applying, by the O-DU to the O-RU, the specific TRx Control configuration based on the obtained parameters; and receiving, by the O-DU from the O-RU, a notification with parameters based on applying the specific TRx Control configuration.
Item [8] An Open Radio Access Network (O-RAN) Distributed Unit (O-DU), configured to: send network energy saving (NES) information including at least one of network traffic, load performance measurements, and Key Performance Indicators (KPI's) to a service management and orchestration (SMO); receive a message indicating when to apply a TRx Control configuration to an O-RAN Radio Unit (O-RU); and set a transceiver (TRx) Control configuration at the O-RU over a fronthaul (FH) interface one of a management plane (M-Plane) or a control plane (C-Plane) based at least in part on the received message; and send to the SMO, a notification indicating whether activation of the TRx control configuration was successful.
Item [9] The O-DU according to Item [8], further configured to: receive from the O-RU, supported TRx Control antenna masks and antenna array configurations, wherein the NES information further includes the supported TRx Control antenna masks and antenna array configurations, and wherein the O-DU and SMO are only allowed to set the TRx Control Configuration that include the supported TRx Control antenna masks and antenna array configurations.
Item [10] The O-DU according to Item [8], wherein the NES information does not include an antenna mask or antenna array configuration, and the O-DU and SMO are enabled to set the TRx Control Configuration to use any of plural antenna mask and antenna array configurations.
Item [11] The O-DU according to any one of Items [8]-[10], wherein the message includes a U-plane Yet Another Generation (YANG) configuration indicating a specific TRx Control configuration.
Item [12] The O-DU according to Item [11], wherein the O-DU is configured to set the TRx Control configuration by: applying to the O-RU, the specific TRx Control configuration; and receiving from the O-RU, a notification with parameters based on applying the specific TRx Control configuration.
Item [13] The O-DU according to any one of Items [8]-[10], wherein the message includes a policy indicating a specific TRx Control configuration.
Item [14] The O-DU according to Item [13], wherein the O-DU is configured to set the TRx Control configuration by: processing the policy to obtain parameters of the TRx Control configuration, applying to the O-RU, the specific TRx Control configuration based on the obtained parameters; and receiving, from the O-RU, a notification with parameters based on applying the specific TRx Control configuration.
Item [15] At least one non-transitory computer-readable recording medium having recorded thereon instructions executable to implement a method including sending, by an Open Radio Access Network (O-RAN) Distributed Unit (O-DU), network energy saving (NES) information including at least one of network traffic, load performance measurements, and Key Performance Indicators (KPI's) to a service management and orchestration (SMO); receiving, by the O-DU, a message indicating when to apply a TRx Control configuration to an O-RAN Radio Unit (O-RU); and setting, by the O-DU, a transceiver (TRx) Control configuration at the O-RU over a fronthaul (FH) interface one of a management plane (M-Plane) or a control plane (C-Plane) based at least in part on the received message; and sending, by the O-DU to the SMO, a notification indicating whether activation of the TRx control configuration was successful.
Item [16] The at least one non-transitory computer-readable recording medium according to Item 15, the method further including: receiving, by the O-DU from the O-RU, supported TRx Control antenna masks and antenna array configurations, wherein the NES information further includes the supported TRx Control antenna masks and antenna array configurations, and wherein the O-DU and SMO are only allowed to set the TRx Control Configuration that include the supported TRx Control antenna masks and antenna array configurations.
Item [17] The at least one non-transitory computer-readable recording medium according to Item [15], wherein the NES information does not include an antenna mask or antenna array configuration, and the O-DU and SMO are enabled to set the TRx Control Configuration to use any of plural antenna mask and antenna array configurations.
Item [18] The at least one non-transitory computer-readable recording medium according to any one of Items [15]-[17], wherein the message includes a U-plane Yet Another Generation (YANG) configuration indicating a specific TRx Control configuration, wherein the setting the TRx Control configuration includes: applying, by the O-DU to the O-RU, the specific TRx Control configuration receiving, by the O-DU from the O-RU, a notification with parameters based on applying the specific TRx Control configuration.
Item [19] The at least one non-transitory computer-readable recording medium according to any one of Items [15]-[17], wherein the message includes a policy indicating a specific TRx Control configuration.
Item [20] The at least one non-transitory computer-readable recording medium according to Item 19, wherein the setting the TRx Control configuration includes: processing, by the O-DU, the policy to obtain parameters of the TRx Control configuration. applying, by the O-DU to the O-RU, the specific TRx Control configuration based on the obtained parameters; and receiving, by the O-DU from the O-RU, a notification with parameters based on applying the specific TRx Control configuration.

It can be understood that numerous modifications and variations of the present disclosure are possible in light of the above teachings. It will be apparent that within the scope of the appended clauses, the present disclosures may be practiced otherwise than as specifically described herein:

What is claimed is:

1. A method, comprising:
sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO);
receiving, by the O-DU, a message indicating when to apply a TRx Control configuration to an O-RAN Radio Unit (O-RU); and
setting, by the O-DU, a transceiver (TRx) Control configuration at the O-RU over a fronthaul (FH) interface one of a management plane (M-Plane) or a control plane (C-Plane) based at least in part on the received message; and
sending, by the O-DU to the SMO, a notification indicating whether activation of the TRx control configuration was successful.

2. The method as claimed in claim 1, further comprising:
receiving, by the O-DU from the O-RU, supported TRx Control antenna masks and antenna array configurations, wherein the NES information further comprises the supported TRx Control antenna masks and antenna array configurations, and wherein the O-DU and SMO are only allowed to set the TRx Control Configuration that include the supported TRx Control antenna masks and antenna array configurations.

3. The method as claimed in claim 1, wherein the NES information does not include an antenna mask or antenna array configuration, and the O-DU and SMO are enabled to set the TRx Control Configuration to use any of plural antenna mask and antenna array configurations.

4. The method as claimed in claim 1, wherein the message comprises a U-plane Yet Another Generation (YANG) configuration indicating a specific TRx Control configuration.

5. The method as claimed in claim 4, wherein the setting the TRx Control configuration comprises:
applying, by the O-DU to the O-RU, the specific TRx Control configuration
receiving, by the O-DU from the O-RU, a notification with parameters based on applying the specific TRx Control configuration.

6. The method as claimed in claim 1, wherein the message comprises a policy indicating a specific TRx Control configuration.

7. The method as claimed in claim 6, wherein the setting the TRx Control configuration comprises:
processing, by the O-DU, the policy to obtain parameters of the TRx Control configuration.
applying, by the O-DU to the O-RU, the specific TRx Control configuration based on the obtained parameters; and
receiving, by the O-DU from the O-RU, a notification with parameters based on applying the specific TRx Control configuration.

8. An Open Radio Access Network (O-RAN) Distributed Unit (O-DU), configured to:
send network energy saving (NES) information comprising at least one of network traffic, load performance measurements, and Key Performance Indicators (KPI's) to a service management and orchestration (SMO);
receive a message indicating when to apply a TRx Control configuration to an O-RAN Radio Unit (O-RU); and
set a transceiver (TRx) Control configuration at the O-RU over a fronthaul (FH) interface one of a management plane (M-Plane) or a control plane (C-Plane) based at least in part on the received message; and
send to the SMO, a notification indicating whether activation of the TRx control configuration was successful.

9. The O-DU as claimed in claim 8, further configured to:
receive from the O-RU, supported TRx Control antenna masks and antenna array configurations, wherein the NES information further comprises the supported TRx Control antenna masks and antenna array configurations, and wherein the O-DU and SMO are only allowed to set the TRx Control Configuration that include the supported TRx Control antenna masks and antenna array configurations.

10. The O-DU as claimed in claim 8, wherein the NES information does not include an antenna mask or antenna array configuration, and the O-DU and SMO are enabled to set the TRx Control Configuration to use any of plural antenna mask and antenna array configurations.

11. The O-DU as claimed in claim 8, wherein the message comprises a U-plane Yet Another Generation (YANG) configuration indicating a specific TRx Control configuration.

12. The O-DU as claimed in claim 11, wherein the O-DU is configured to set the TRx Control configuration by:
applying to the O-RU, the specific TRx Control configuration; and
receiving from the O-RU, a notification with parameters based on applying the specific TRx Control configuration.

13. The O-DU as claimed in claim 8, wherein the message comprises a policy indicating a specific TRx Control configuration.

14. The O-DU as claimed in claim 13, wherein the O-DU is configured to set the TRx Control configuration by:
processing the policy to obtain parameters of the TRx Control configuration.
Applying to the O-RU, the specific TRx Control configuration based on the obtained parameters; and
receiving, from the O-RU, a notification with parameters based on applying the specific TRx Control configuration.

15. At least one non-transitory computer-readable recording medium having recorded thereon instructions executable by at least one processor to implement a method comprising:
sending, by an Open Radio Access Network (O-RAN) Distributed Unit (O-DU), network energy saving (NES) information comprising at least one of network traffic, load performance measurements, and Key Performance Indicators (KPI's) to a service management and orchestration (SMO);
receiving, by the O-DU, a message indicating when to apply a TRx Control configuration to an O-RAN Radio Unit (O-RU); and
setting, by the O-DU, a transceiver (TRx) Control configuration at the O-RU over a fronthaul (FH) interface one of a management plane (M-Plane) or a control plane (C-Plane) based at least in part on the received message; and
sending, by the O-DU to the SMO, a notification indicating whether activation of the TRx control configuration was successful.

16. The at least one non-transitory computer-readable recording medium as claimed in claim 15, the method further comprising:
receiving, by the O-DU from the O-RU, supported TRx Control antenna masks and antenna array configurations, wherein the NES information further comprises the supported TRx Control antenna masks and antenna array configurations, and wherein the O-DU and SMO are only allowed to set the TRx Control Configuration that include the supported TRx Control antenna masks and antenna array configurations.

17. The at least one non-transitory computer-readable recording medium as claimed in claim 15, wherein the NES information does not include an antenna mask or antenna array configuration, and the O-DU and SMO are enabled to set the TRx Control Configuration to use any of plural antenna mask and antenna array configurations.

18. The at least one non-transitory computer-readable recording medium as claimed in claim 15, wherein the message comprises a U-plane Yet Another Generation (YANG) configuration indicating a specific TRx Control configuration, wherein the setting the TRx Control configuration comprises:
applying, by the O-DU to the O-RU, the specific TRx Control configuration receiving, by the O-DU from the O-RU, a notification with parameters based on applying the specific TRx Control configuration.

19. The at least one non-transitory computer-readable recording medium as claimed in claim 15, wherein the message comprises a policy indicating a specific TRx Control configuration.

20. The at least one non-transitory computer-readable recording medium as claimed in claim 19, wherein the setting the TRx Control configuration comprises:
processing, by the O-DU, the policy to obtain parameters of the TRx Control configuration.
applying, by the O-DU to the O-RU, the specific TRx Control configuration based on the obtained parameters; and
receiving, by the O-DU from the O-RU, a notification with parameters based on applying the specific TRx Control configuration.
